(19) United States
(12) Patent Application Publication
(10) Pub. No.: US 2009/0001046 A1
(43) Pub. Date: Jan. 1, 2009

(54) SUBSTRATE PROCESSING METHOD, SUBSTRATE PROCESSING APPARATUS AND RECORDING MEDIUM

(75) Inventors: Kazuhiro KUBOTA, Yamanashi (JP); Shigeru Tahara, Yamanashi (JP); Ryuichi Asako, Yamanashi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/138,780

(22) Filed: Jun. 13, 2008

Related U.S. Application Data
(60) Provisional application No. 60/971,943, filed on Sep. 13, 2007.

(30) Foreign Application Priority Data
Jun. 26, 2007 (JP) 2007-168132

(51) Int. Cl. H01B 13/00

(52) U.S. Cl. 216/13; 156/345.54

(57) ABSTRACT

The present invention provides a method, an apparatus and the like that may be adopted when executing a specific type of processing on a substrate that includes a recessed portion formed by etching a low dielectric constant insulating film with a low dielectric constant having been formed upon a metal layer. More specifically, a hydrogen radical processing phase in which the surface of the metal layer exposed at the bottom of the recessed portion is cleaned and the low dielectric constant insulating film is dehydrated by supplying hydrogen radicals while heating the substrate to a predetermined temperature and a hydrophobicity processing phase in which the low dielectric constant insulating film exposed at a side surface of the recessed portion is rendered hydrophobic by supplying a specific type of processing gas to the substrate are executed in succession without exposing the substrate to air.

### CROSS-REFERENCE TO RELATED APPLICATIONS

This document claims priority to Japanese Patent Application Number 2007-168132, filed on Jun. 26, 2007 and U.S. Provisional Application No. 60/971,943, filed on Sep. 13, 2007, the entire content of which are hereby incorporated by reference.

### FIELD OF THE INVENTION

The present invention relates to a substrate processing method, a substrate processing apparatus and a recording medium.

### BACKGROUND OF THE INVENTION

As an increasingly higher extent of integration is achieved in semiconductor integrated circuits in recent years, semiconductor devices need to adopt a multilayer wiring structure allowing wiring is to be stacked over many layers. A semiconductor device adopting a multilayer wiring structure needs to include trench wiring that connects various elements laid out along the horizontal direction and via hole wiring for connecting various elements layered along the vertical direction. A low-resistance metal with outstanding anti-electromigration property, such as copper, is often used as the wiring material and a highly porous low-k material that assures a low dielectric constant, is often used as the interlayer insulating material so as to achieve higher speed in the integrated circuit.

A wiring structure constituted with a low-k film and a copper wiring, such as that described above, may be formed as described below through, for instance, the damascene method. First, an insulating film is formed on a substrate and a wiring layer is formed by burying a copper wiring in the insulating film. Next, an etching stopper film, an interlayer dielectric film constituted of a low-k material, a capping film and an anti-reflection coating are formed in this order over the wiring layer. Then, a photoresist film with a specific pattern corresponding to the wiring pattern is formed over the anti-reflection coating by using a photolithography technology. The photoresist film is used as a mask while etching through the anti-reflection coating, the capping film, the low-k film and the etching stopper film. As a result, a groove (trench) or a hole (via) to be used as a wiring recess is formed at the low-k film, with the surface of the copper wiring exposed at the bottom of the wiring groove or the wiring hole.

Next, the substrate undergoes an ashing process to remove the photoresist film and the anti-reflection coating. Subsequently, a wiring metal, e.g., copper, is embedded in the wiring groove or the wiring hole formed at the low-k film, and finally, any excess metal is removed through chemical-mechanical polishing (CMP). Part of the multilayer wiring structure is completed by thus connecting the horizontal copper wiring (wiring layer) with the vertical copper wiring.

If the anti-reflection coating, the capping film, the low-k film, and the etching stopper film are etched by using a processing gas constituted with a fluorine-containing gas such as CF₄, a CuF film may be formed at the surface of the copper wiring exposed at the bottom of the wiring groove or the wiring hole. In addition, if the substrate with the copper wiring exposed as described above is exposed to air, a CuO film may be formed at the exposed surface of the copper wiring.

If copper is embedded to fill the wiring groove or the wiring hole to connect the horizontal copper wiring (wiring layer) with the vertical copper wiring with an undesirable copper compound film present at the surface of the copper wiring exposed at the bottom of the wiring groove or the wiring hole, the electrical resistance will increase over the connection area, giving rise to a concern that desirable electrical characteristics may not be achieved in the multilayer wiring structure.

As described earlier, a porous low-k material, which assures a lower dielectric constant, is often used as the interlayer insulating material in recent years. While such a porous low-k material provides significant advantages when used as the interlayer insulating material, it absorbs water readily and thus gives rise to a concern that the moisture having penetrated the film may compromise both the electrical characteristics and the mechanical characteristics. More specifically, if the low-k film contains moisture, the dielectric constant of the low-k film increases, resulting in an increase in the interlayer capacity in the multilayer wiring structure and a delay in electric signal transmission.

In addition, as circuits today adopt increasingly fine circuit structures, the width of the opening at the wiring groove or the wiring hole formed at the low-k film, too, is becoming ever smaller. If moisture penetrates such a low-k film and reduces the mechanical strength of the film, a wiring groove or a wiring hole with a desired shape can no longer be formed with ease. Furthermore, if the low-k film does not have sufficient mechanical strength, the film cannot retain its shape and thus, various types of films cannot be stacked on the low-k film. As a result, a wiring structure with a greater number of players cannot be formed reliably. There is an added concern that the film in contact with the surface of the low-k film may become separated from the low-k film.

Moreover, an interlayer dielectric film constituted of a material having a low dielectric constant such as a low-k film becomes readily damaged during an etching process or an ashing process (e.g., an ashing process executed by using oxygen plasma. Water tends to be absorbed more readily over a damaged area in the interlayer dielectric film. For this reason, as the interlayer dielectric film having undergone the etching process or the ashing process is taken out and exposed to air and moisture from the air is absorbed by the interlayer dielectric film, the electrical characteristics and the mechanical characteristics of the interlayer dielectric film may become significantly compromised.

Japanese Laid Open Patent Publication No. 2006-049798 (Patent reference literature 1) addresses these concerns by disclosing a technology whereby an interlayer dielectric film (low-k film) having undergone an etching process further undergoes a silylation process to silylate the side surface of the wiring groove or the wiring hole formed in the interlayer dielectric film without exposing the interlayer dielectric film to air, thereby restoring it from any damage it may have been subjected to and preventing an increase in the dielectric constant of the interlayer dielectric film attributable to water absorbed into the interlayer dielectric film.

However, while the technology disclosed in patent reference literature 1 prevents any additional water from becoming absorbed into the interlayer dielectric film by silylating the interlayer dielectric film having undergone the etching process and thus restoring it from any damage that may have occurred at the surface of the interlayer dielectric film during the etching process, the publication does not disclose effective measures for removing the water already present in the interlayer dielectric film to a sufficient extent. Thus, there is bound to be a limit to how much the electrical characteristics and the mechanical strength of the interlayer dielectric film can be improved.

In addition, even when the side surfaces of the wiring groove or the wiring hole formed in the interlayer dielectric film are silylated, a metal compound film such as a CuO film or a CuF film, which may have been formed at the surface of the copper wiring exposed at the bottom of the wiring groove or the wiring hole cannot be removed. For this reason, the electrical resistance of the copper wiring is bound to be high.

Also, the metal compound film formed on the exposed surface of the copper wiring cannot be removed through an ashing process executed by using oxygen plasma as described earlier, as long as the surface of the copper wiring having become exposed at the bottom of the wiring groove or the wiring hole through the etching process is present. Rather, the process of oxidation will progress further during the ashing process. This means that even if silylation processing is executed immediately afterwards in order to recover from damage having occurred during the etching process or the ashing process, the metal compound film at the exposed surface of the copper wiring will not be removed.

### SUMMARY OF THE INVENTION

Accordingly, an object of the present invention, having been completed by addressing the issues discussed above, is to provide a substrate processing method and the like, which make it possible to release water in an insulating film with a low dielectric constant exposed at a recessed portion having been formed on a substrate through an etching process, disallow ready absorption of any additional water into the insulating film and remove an undesirable metal compound formed at a metal layer having become exposed at the recessed portion through the etching process or the like.

The object described above is achieved in an aspect of the present invention by providing a substrate processing method adopted when executing a specific type of processing on a processing target substrate that includes a metal layer, a low dielectric constant insulating film with a low dielectric constant formed over the metal layer and a recessed portion formed in the low dielectric constant insulating film by etching the low dielectric constant insulating film until the metal layer becomes exposed, comprising a hydrogen radical processing phase in which the surface of the metal layer exposed at the recessed portion is cleaned and the low dielectric constant insulating film is dehydrated by supplying hydrogen radicals to the processing target substrate being heated to a predetermined temperature and a hydrophobicity processing phase, in which the low dielectric constant insulating film exposed at the recessed portion is rendered hydrophobic by supplying a specific processing gas to the processing target substrate having undergone the hydrogen radical processing. The hydrogen radical processing phase and the hydrophobicity processing phase constituting the substrate processing method are executed in succession without exposing the target processing substrate to air. It is to be noted that the hydrogen radical processing phase and the hydrophobicity processing phase may be executed in a single processing chamber or they may be executed in different processing chambers. It is desirable that the processing target substrate be transferred in a low pressure environment at least while the processing target substrate travels from the processing chamber where the hydrogen radical processing phase is executed to the processing chamber where the hydrophobicity processing phase is executed.

The object described above is also achieved in another aspect of the present invention by providing a substrate processing apparatus capable of executing a specific type of processing on a processing target substrate that includes a metal layer, a low dielectric constant insulating film with a low dielectric constant formed over the metal layer and a recessed portion formed in the low dielectric constant insulating film by etching the low dialectic constant insulating film until the metal layer becomes exposed, comprising a hydrogen radical processing chamber in which the surface of the metal layer and exposed at the recessed portion is cleaned and the low dielectric constant insulating film is dehydrated by supplying hydrogen radicals to the processing target substrate being heated to a predetermined temperature, a hydrophobicity processing chamber in which the low dielectric constant insulating film exposed at the recessed portion is rendered hydrophobic by supplying a specific processing gas to the processing target substrate having undergone the hydrogen radical processing while the low dialectic constant insulating film is further dehydrated and a common low-pressure transfer chamber connected to both processing chambers, via which the processing target substrate can be transferred in a low pressure environment between the processing chambers.

The object described above is further achieved in yet another aspect of the present invention by providing a computer-readable recording medium having recorded therein a program enabling a computer to execute steps of a substrate processing method adopted when executing a specific type of processing on a processing target substrate that includes a metal layer, a low dielectric constant insulating film with a low dielectric constant formed over the metal layer and a recessed portion formed in the low dielectric constant insulating film by etching the low dielectric constant insulating film until the metal layer becomes exposed. The program enables the computer to execute a step in which the processing target substrate is transferred in a low pressure environment into a hydrogen radical processing chamber, a hydrogen radical processing step in which the pressure inside the hydrogen radical processing chamber is lowered and the surface of the metal layer exposed at the recessed portion is cleaned and the low dielectric constant insulating film is dehydrated in a low pressure environment achieving a specific degree of vacuum by supplying hydrogen radicals to the processing target substrate being heated to a predetermined temperature, a step in which the processing target substrate having undergone the hydrogen radical processing is transferred in a low pressure environment into a hydrophobicity processing chamber and a hydrophobicity processing step in which the pressure in the hydrophobicity processing chamber is lowered and the low dielectric constant insulating film exposed at the recessed portion is rendered hydrophobic in a low pressure environment achieving a specific degree of vacuum by supplying a specific processing gas to the processing target substrate.

According to the present invention described above, the water present in the low dielectric constant insulating film can be released to a sufficient extent through the hydrogen radical processing and the low dielectric constant insulating film exposed at the recessed portion can be rendered hydrophobic through the hydrophobicity processing executed in direct succession following the hydrogen radical processing. As a result, the water content in the low dielectric constant insulating film can be reduced to a sufficient extent and also, any further absorption of water into the low dielectric constant insulating film is effectively prevented. This, in turn, improves the electrical characteristics and the mechanical strength of the low dielectric constant insulating film. The surface of the metal layer exposed at the recessed portion is cleaned through the hydrogen radical processing and thus, any undesirable metal compound that may have been formed during the etching process or the like at the exposed surface of the metal layer can be removed through the hydrogen radical processing. Consequently, any wiring metal embedded in the recessed portion can be connected to the metal layer with less resistance.

In addition, the hydrogen radical processing phase and the hydrophobicity processing phase are executed in succession in a low pressure environment without exposing the processing target substrate to air. Thus, even if the hydrogen radical processing renders the composition of the low dielectric constant insulating film exposed at the recessed portion to that which allows ready water absorption, reabsorption of water into the low dielectric constant insulating film prior to completion of the subsequent hydrophobicity processing can be effectively prevented.

It is desirable that the processing target substrate be heated during the hydrogen radical processing so as to maintain the temperature of the processing target substrate at a predetermined level within a range of 250° C.˜400° C. By maintaining the temperature of the processing target substrate within this range, water already present in the low dielectric constant insulating film, as well as water present at the surface of the low dielectric constant insulating film can be released to a full extent without subjecting the low dielectric constant insulating film to any thermal damage.

Through the hydrophobicity processing phase, the low dielectric constant insulating film is rendered hydrophobic as a water-repellent layer is formed at the exposed surface of the low dielectric constant insulating film through a chemical reaction with the specific processing gas. The presence of such a water-repellent layer prevents reabsorption of water into the low dielectric constant insulating film. The specific gas used during this phase should be a silylating gas obtained from a compound that includes, for instance, a silazane (Si—N) bond within the molecules thereof. In such a case, a water-repellent layer will be formed as the exposed surface of the low dielectric constant insulating film having become damaged during the etching process or the like is silylated with the silylating gas. Namely, through the use of the silylating gas, a water-repellent layer is formed while restoring the quality of the low dielectric constant insulating film having been damaged during the etching process.

The object described above is achieved in another aspect of the present invention by providing a substrate processing method adopted when executing a specific type of processing on a processing target substrate that includes a metal layer and a low dielectric constant insulating film with a low dielectric constant formed over the metal layer, comprising an etching processing phase in which a recessed portion is formed in the low dielectric constant insulating film by etching the low dielectric constant insulating film until the metal layer becomes exposed, a hydrogen radical processing phase in which the surface of the metal layer exposed at the recessed portion is cleaned and the low dielectric constant insulating film is dehydrated by supplying hydrogen radicals to the processing target substrate while heating to a predetermined temperature the processing target substrate having undergone the etching processing and a hydrophobicity processing phase in which the low dielectric constant insulating film exposed at the recessed portion is rendered hydrophobic by supplying a specific processing gas to the processing target substrate having undergone the hydrogen radical processing. The etching processing phase, the hydrogen radical processing phase and the hydrophobicity processing phase constituting the substrate processing method are executed in succession without exposing the target processing substrate to air.

The object is also achieved in an aspect of the present invention by providing a substrate processing apparatus capable of executing a specific type of processing on a processing target substrate that includes a metal layer and a low dielectric constant insulating film with a low dielectric constant formed over the metal layer, comprising an etching processing chamber in which a recessed portion is formed in the low dielectric constant insulating film by etching the low dielectric constant insulating film until the metal layer becomes exposed, a hydrogen radical processing chamber in which the surface of the metal layer exposed at the recessed portion is cleaned and the low dielectric constant insulating film is dehydrated by supplying hydrogen radicals to the processing target substrate while heating to a predetermined temperature, the processing target substrate having undergone the etching processing, a hydrophobicity processing chamber in which the low dielectric constant insulating film exposed at the recessed portion is rendered hydrophobic by supplying a specific processing gas to the processing target substrate having undergone the hydrogen radical processing and a low-pressure transfer chamber that includes a substrate transfer mechanism capable of transferring the processing target substrate in a low pressure environment among the etching processing chamber, the hydrogen radical processing chamber and the hydrophobicity processing chamber.

According to the present invention described above, the etching processing, the hydrogen radical processing and the hydrophobicity processing can be executed in succession without exposing the processing target substrate to air and thus, absorption of water into the low dielectric constant insulating film during the interval between the etching processing and the hydrogen radical processing as well as during the interval between the hydrogen radical processing and the hydrophobicity processing can be effectively prevented. In addition, since the hydrogen radical processing and the hydrophobicity processing are executed in succession after the low dielectric constant insulating film undergoes the etching processing, reabsorption of water into the low dielectric constant insulating film is effectively prevented once the water content in the film has been sufficiently lowered and any undesirable metal compound formed at the exposed surface of the metal layer during the etching process or the like can be eliminated.

According to the present invention, water present in the low dielectric constant insulating film exposed at the recessed portion formed by etching the substrate is first released to a sufficient extent, further absorption of water is inhibited and any undesirable metal compound formed at the metal layer having become exposed at the recessed portion through the etching processing or the like can be removed. As a result, the electrical resistance at the metal wiring can be kept to a low level, the low dielectric constant insulating film is allowed to sustain its low dielectric constant and a reduction in the mechanical strength of the low dielectric constant insulating film is prevented which, in turn, allows, a multilayer wiring structure with superior electrical characteristics and mechanical strength to be formed on the substrate.

### BRIEF DESCRIPTION OF THE DRAWINGS

FIG. 1 is a lateral sectional view presenting a structural example that may be adopted in the substrate processing apparatus achieved in an embodiment of the present invention;

FIG. 2 is a block diagram of a structural example that may be adopted in the control unit in FIG. 1;

FIG. 3 is a longitudinal sectional view presenting a structural example that may be adopted in the etching processing chambers in the substrate processing apparatus in the embodiment;

FIG. 4 is a longitudinal sectional view presenting a structural example that may be adopted in the hydrogen radical processing chamber in the substrate processing apparatus in the embodiment;

FIG. 5 is a longitudinal sectional view presenting a structural example that may be adopted in the hydrophobicity processing chamber in the substrate processing apparatus in the embodiment;

FIG. 6 is a sectional view presenting a specific example of a preprocessing film structure at a processing target wafer to undergo processing in the substrate processing apparatus in the embodiment;

FIG. 7 presents a flowchart showing the flow with which the individual phases are executed in the wafer processing in the substrate processing apparatus in the embodiment;

FIG. 8 is a sectional view presenting an example of a film structure that may be achieved on the wafer having undergone the etching processing;

FIG. 9 is a sectional view presenting an example of a film structure that may be achieved on the wafer having undergone the hydrogen radical processing;

FIG. 10 is a sectional view presenting an example of a film structure that may be achieved on the wafer having undergone the hydrophobicity processing;

FIG. 11A is a graph presenting test results indicating the moduli of elasticity of a low-k film having undergone the hydrogen radical processing alone, measured immediately after the hydrogen radical processing (y_{A}) and also after allowing a 48-hour interval during which the low-k film was left at atmospheric pressure (y_{B});

FIG. 11B is a graph presenting test results indicating the moduli of elasticity of a low-k film having undergone the hydrogen radical processing alone, measured immediately after the hydrogen radical processing (y_{A}) and also after allowing a 48-hour interval during which the low-k film was left in a low pressure environment (y_{C}); and

FIG. 11C is a graph presenting test results indicating the moduli of elasticity of a low-k film having undergone the hydrogen radical processing and the hydrophobicity processing executed in succession, measured immediately after the hydrogen radical processing (y_{D}) and also after a 48-hour interval during which the low-k film was left in a low pressure environment (y_{E}).

### DETAILED DESCRIPTION OF THE PREFERRED EMBODIMENT

The following is a detailed explanation of the preferred embodiment of the present invention given in reference to the attached drawings. It is to be noted that in the description and the drawings, the same reference numerals are assigned to components having substantially identical functions and structural features to preclude the necessity for a repeated explanation thereof.

(Structural Example for the Substrate Processing Apparatus)

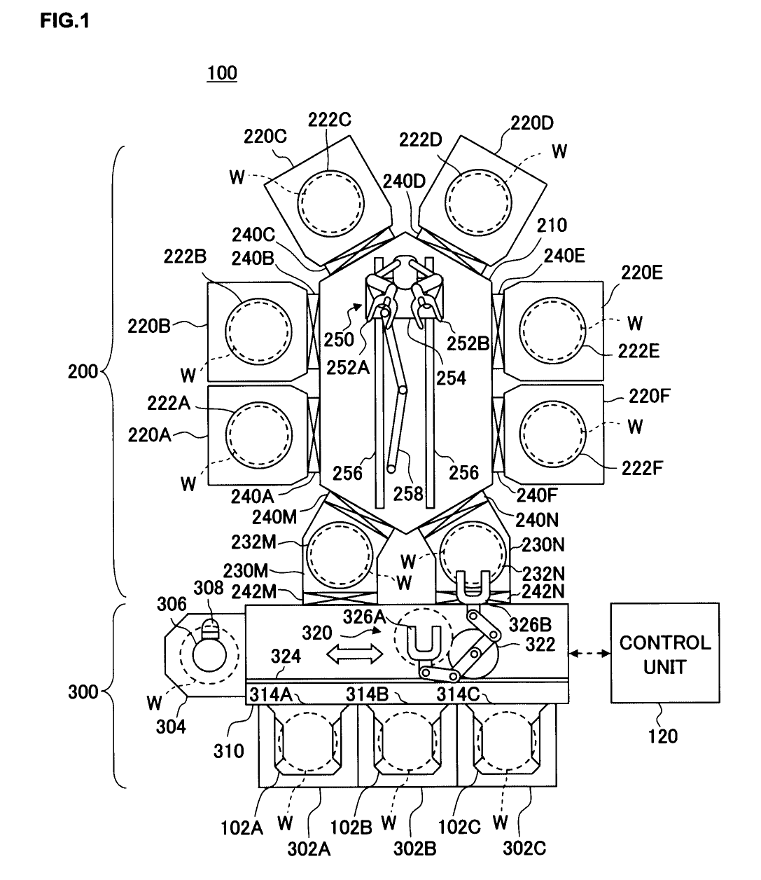

The substrate processing apparatus achieved in the embodiment of the present invention is explained first in reference to the drawings. FIG. 1 schematically illustrates the structure adopted in the substrate processing apparatus achieved in the embodiment of the present invention. The substrate processing apparatus 100 comprises a processing unit 200 equipped with a plurality of processing chambers where various types of processing such as etching and surface treatment are executed on substrates such as semiconductor wafers W in a low pressure environment, a transfer unit 300 via which a wafer W is carried into/out of the processing unit 200 at atmospheric pressure and a control unit 120 that executes overall control for the operations executed in the substrate processing apparatus 100.

The transfer unit 300 includes an atmospheric pressure-side transfer chamber 310 via which the wafer W is transferred between a substrate storage container such as a cassette container 102 (102A˜102C) and the processing unit 200. The transfer chamber 310 is formed in a box shape with a substantially polygonal section. A plurality of cassette tables 302 (302A˜302C) are set next to one another along one of the side surfaces of the transfer chamber 310 ranging along the longer side of its substantially polygonal section. The cassette containers 102A˜102C can be placed respectively upon the cassette tables 302A˜302C.

At each of the cassette containers 102 (102A˜102C) up to, for instance, 25 wafers W, with their ends held by a holding portion, are stacked over multiple levels with a uniform pitch for storage. The cassette containers have a sealed structure that allows the inner spaces to be filled with, for instance, nitrogen (N₂) gas. At the side surface of the transfer chamber 310, along which the plurality of cassette tables 302 (302A˜302C) are disposed side-by-side, transfer ports 314 (314A˜314C) are formed and wafers W can thus be transferred between the individual cassette containers 102 (102A˜102C) and the transfer chamber 310 via the transfer ports 314 (314A˜314C). It is to be noted that the numbers of the cassette tables 302 and the cassette containers 102 in the substrate processing apparatus are not limited to the examples presented in FIG. 1.

At an end of the transfer chamber 310, i.e., at a side surface of the transfer chamber ranging along the shorter side of its substantially polygonal section, an orienter (pre-alignment stage) 304 to function as a positioning device, which includes a rotary stage 306 and an optical sensor 308 for optically detecting the edge of a wafer W both provided as built-in units, is located. The orienter 304 positions the wafer W by detecting, for instance, an orientation flat or a notch at the wafer W.

Inside the transfer chamber 310, the transfer unit-side transfer mechanism 320 which transfers the wafer W along the lengthwise direction (indicated by the arrow in FIG. 1) is disposed. A base 322 to which the transfer unit-side transfer mechanism 320 is fixed is slidably supported on a guide rail 324 laid along the lengthwise direction inside the transfer chamber 310. A mover and a stator of a linear motor are respectively disposed at the base 322 and the guide rail 324. At an end of the guide rail 324, a linear motor drive mechanism (not shown) via which the linear motor is driven is disposed. As the linear motor drive mechanism is control based upon a control signal sent by the control unit 120, the transfer unit-side transfer mechanism 320 moves along the lengthwise direction on the guide rail 324 together with the base 322.

The transfer unit-side transfer mechanism 320 adopts a double arm structure, which includes two arm units. In addition, the arm units are each articulated, which allows them to extend, retract, move up/down and swing freely to the sides. In addition, end effectors 326A and 326B used to hold wafers W are mounted at the front ends of the arms and thus, the transfer unit-side transfer mechanism 320 is able to handle two wafers W at once. Via this transfer unit-side transfer mechanism 320, wafers W can be carried into/out of, for instance, the cassette containers 102, the orienter 304, and first and second load lock chambers 230M and 230N to be detailed later so as to replace a wafer W present therein with a new wafer W. A sensor (not shown) capable of detecting the presence of a wafer W held thereat is mounted at each of the end effectors 326A and 326B of the transfer unit-side transfer mechanism 320. It is to be noted that the number of arm units in the transfer unit-side transfer mechanism 320 is not limited to that described above and the transfer unit-side transfer mechanism 320 may adopt, for instance, a single arm structure that includes a single arm unit, instead.

Next, a structural example that may be adopted in the processing unit 200 is described. The processing unit 200 in the cluster tool type processing apparatus 100 in the embodiment, includes a common transfer chamber 210 formed to have a polygonal (e.g., a hexagonal) section, the plurality of processing chambers 220 (first through sixth processing chambers 220A˜220F) connected around the common transfer chamber while sustaining air tightness and the first and second load lock chambers 230M and 230N as shown in FIG. 1. In the processing chambers 220A˜220F, a specific single type of processing or specific different types of processing, e.g., hydrogen radical processing and hydrophobicity processing to be detailed later as well as etching, are executed on wafers W based upon processing recipes and the like stored in advance in a storage medium or the like in the control unit 120. Stages 222 (222A˜222F) upon which wafers W are placed are respectively disposed inside the individual processing chambers 220 (220A˜220F). The structures adopted in the individual processing chambers 220 are to be detailed later. It is to be noted that the number of processing chambers 220 in the processing unit is not limited to that shown in FIG. 1.

The common transfer chamber 210 adopts a structure that allows its internal space to be controlled to maintain a specific degree of vacuum. Via the common transfer chamber, wafers W are carried to be transferred among the individual processing chambers 220A˜220F and also from the individual chambers 220A˜220F to the first and second load lock chambers 230M and 230N. The common transfer chamber 210 is formed in a polygonal shape (e.g., a hexagonal shape), with the processing chambers 220 (220A˜220F) connected around the common transfer chamber via gate valves 240 (240A˜240F) respectively, with the front ends of the first and second load lock chambers 230M and 230N also connected around the common transfer chamber via gate valves (low pressure-side gate valves) 240M and 240N respectively. The base ends of the first and second load lock chambers 230M and 230N are connected to the other side surface of the transfer chamber 310 ranging along the longer side of the substantially polygonal section respectively via gate valves (atmospheric pressure-side gate valves) 242M and 242N.

The first and second load lock chambers 230M and 230N have a function of temporarily holding wafers W and passing them on to the next process upon completing pressure adjustment. Inside the first and second load lock chambers 230M and 230N, transfer stages 232M and 232N upon which wafers W can be placed are respectively disposed.

Inside the common transfer chamber 210, a processing unit-side transfer mechanism 250 constituted with an articulated arm capable of extending, retracting, moving up/down and swinging to the sides is disposed. The processing unit-side transfer mechanism 250 includes two end effectors 252A and 252B, which enable it to handle two wafers W at once. In addition, the processing unit-side transfer mechanism 250 is rotatably supported at a base 254. The base 254 slides freely on a guide rail 256 laid out to range from the base end side toward the front end side inside the common transfer chamber 210 via, for instance, a slide-drive motor (not shown). It is to be noted that a flexible arm 258, through which the wiring for, for instance, an arm swinging motor and the like pass is connected to the base 254. The processing unit-side transfer mechanism 250 structured as described above, is able to access the first and second load lock chambers 230M and 230N and the individual processing chambers 220A˜220F by sliding along the guide rail 256.

For instance, the processing unit-side transfer mechanism 250 should be positioned toward the base end side in the common transfer chamber 210 along the guide rail 256 in order to access the first or second load lock chamber 230M or 230N or either of the processing chambers 220A and 220F facing opposite each other. In order to access any of the four processing chambers 220B˜220E, the processing unit-side transfer mechanism 250 should be positioned toward the front end side of the common transfer chamber 210 along the guide rail 256. Thus, all the processing chambers 220A˜220F and both the first load lock chamber 230M and the second load lock chamber 230N, each connected to the common transfer chamber 210, can be accessed via a single processing unit-side transfer mechanism 250.

It is to be noted that the processing unit-side transfer mechanism may adopt a structure other than that described above and may include, for instance, two transfer mechanisms. Namely, a first transfer mechanism constituted with an articulated arm capable of extending, retracting, moving up/down and swinging to the sides may be disposed toward the base end side of the common transfer mechanism 210 and a second transfer mechanism constituted with an articulated arm capable of extending, retracting, moving up/down and swinging to the sides may be disposed toward the front end side of the common transfer chamber 210. In addition, the number of end effectors in the processing unit-side transfer mechanism 250 does not need to be two and the processing unit-side transfer mechanism may instead include a single end effector.

(Structural Example for the Control Unit)

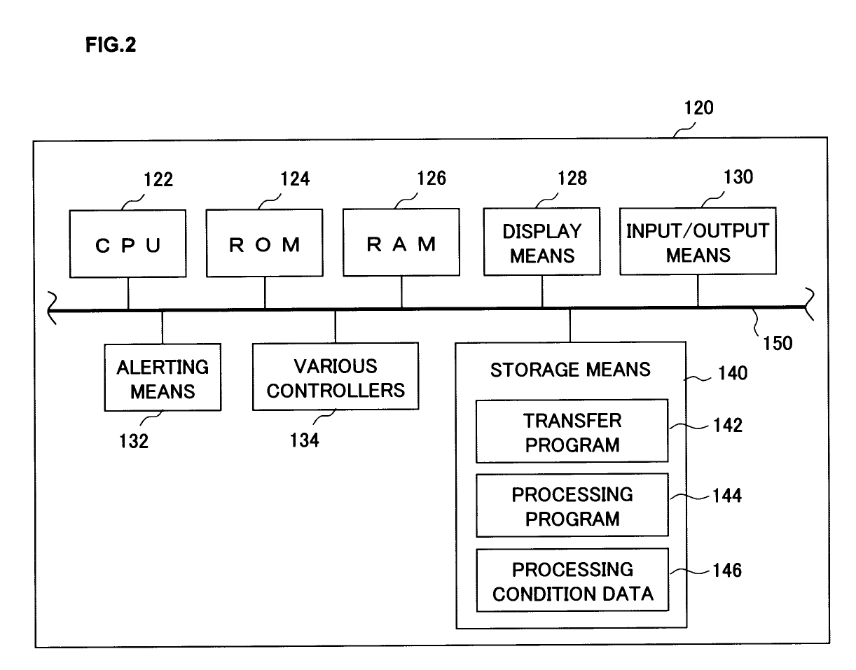

Next, a specific structural example that may be adopted in the control unit 120 is described in reference to a drawing. FIG. 2 is a block diagram showing the structure adopted in the control unit 120. As explained earlier, the control unit 120 controls the overall operations executed in the substrate processing apparatus 100, such as wafer processing control under which wafers W are processed in the individual processing chambers 220, displacement control for the transfer unit-side transfer mechanism 320 and the processing unit-side transfer mechanism 250, open/close control for the various gate valves 240 and 242 and rotation control for the rotary stage 306 at the orienter 304.

The control unit 120 that executes such control includes a CPU (central processing unit) 120 constituting the control unit main unit, a ROM (read-only memory) 124 in which data and the like used by the CPU 122 to control the individual units are stored, a RAM (random-access memory) 126 having a memory area used for various types of data processing executed by the CPU 122 and the like, a display means 128 constituted with a liquid crystal display or the like, at which operation screens, selection screens and the like are brought upon display, an input/output means 130 via which the operator is able to input/output various types of data, an alerting means 132 constituted with an alarm device such as a buzzer, various controllers 134 functioning as module controllers that individually control specific module units such as the processing chambers 220A˜220F, the common transfer chamber 210, the transfer chamber 310 and the orienter 304 in the substrate processing apparatus 100, and a storage means 140 for storing program data constituting various programs used in the substrate processing apparatus 100 and various types of setting information used when program processing is executed based upon the program data.

In the storage means 140, a transfer program 142 based upon which the operations of the transfer unit-side transfer mechanism 320 and the processing unit-side transfer mechanism 250 are controlled, a processing program 144 executed when processing wafers W in the processing chambers 220 and the like are stored. In addition, processing condition (recipe) data 146 indicating processing conditions, e.g., the chamber internal pressures, the gas flow rates, the high frequency power levels and the like, under which the processing is to be executed in the individual processing chambers 220 are stored in the storage means 140. The data stored in the storage means 140, which may be constituted with a recording medium such as a flash memory, a hard disk or a CD-ROM, are read out by the CPU 122 as necessary.

The CPU 122, the ROM 124, the RAM 126, the display means 128, the input/output means 130, the alerting means 132, the various controllers 134 and the storage means 140 constituting the control unit 120 are electrically connected with one another via a bus line 150 which may be a control bus, a system bus or a data bus.

(Structural Examples for the Processing Chambers)

Next, structural example that may be adopted in the processing chambers of the substrate processing apparatus 100 shown in FIG. 1 are described. The substrate processing apparatus 100 may adopt a structure that enables it to successively execute; etching processing through which a low dielectric constant insulating film with a low dielectric constant (e.g., a low-k film) formed on an Si wafer is selectively etched based upon a specific pattern, hydrogen radical processing through which a film surface having become exposed through the etching process is cleaned and water in the low-k film is released (dehydration) and hydrophobicity processing through which at least the exposed surface of the low-k film is rendered hydrophobic. In the embodiment, the processing chambers 220A, 220B, 220E and 220F may be designated as etching processing chambers, the processing chamber 220C may be designated as a hydrogen radical processing chamber and the processing chamber 220D may be designated as a hydrophobicity processing chamber. It is to be noted that by adjusting the combination of processing designations to the individual processing chambers 220A˜220F, the details of the actual processing to be executed in the substrate processing apparatus 100 can be altered. The following is a detailed explanation of specific structural examples that may be adopted in the processing chambers 220A˜220F.

(Structural Example for the Etching Processing Chambers)

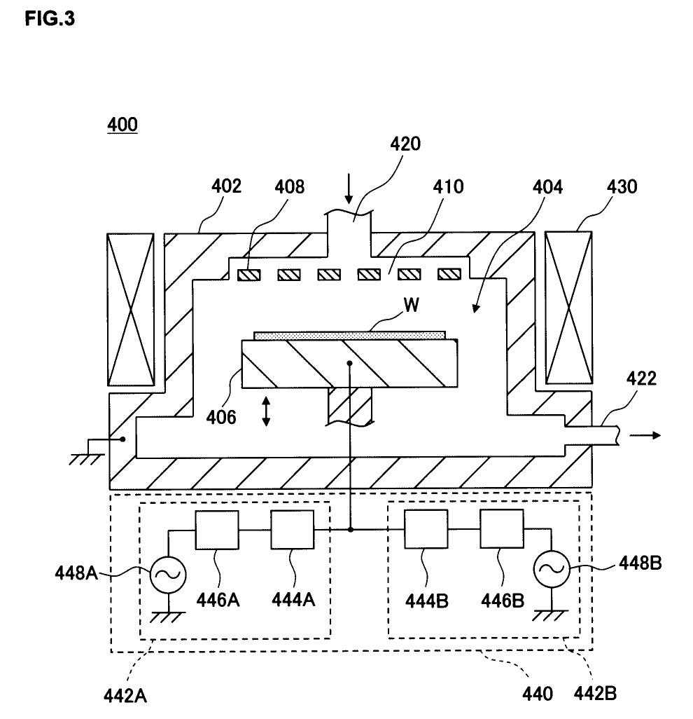

First, a specific structural example that may be adopted in the processing chambers 220A, 220B, 220E and 220F in FIG. 1, designated as etching processing chambers, is described in reference to a drawing. FIG. 3 is a longitudinal sectional view schematically illustrating a structure that may be adopted in the etching processing chambers in the embodiment. In the etching processing chamber 400 in the figure, etching processing is executed to selectively etch a low-k film formed on, for instance, a Si wafer by using a specific pattern. Since the structures of the processing chambers 220A, 220B, 220E and 220F are identical, the following explanation is provided by assuming the etching processing chamber 400 is a specific processing chamber among them, i.e., the processing chamber 220A.

As shown in FIG. 3, the etching processing chamber 400 includes a grounded processing container 402 constituted of, for instance, metal (e.g., aluminum or stainless steel). An electrically conductive lower electrode 406 also functioning as a stage on which a wafer W is placed is disposed so as to move up/down freely inside a highly airtight internal space 404 enclosed by the processing container 402.

It is to be noted that although not shown, a transfer port through which a wafer W is carried into/out of the processing container 402 is formed at a side wall toward the bottom of the processing container. This transfer port is opened/closed via the gate valve 240A, shown in FIG. 1. As the gate valve 240A is set in the open state, a wafer transfer between the etching processing chamber 400 and the common transfer chamber 210 is enabled. For wafer transfer, the lower electrode 406 is lowered to a specific position closer to the bottom, whereas the lower electrode 406 is raised to a specific position closer to the top when executing the etching processing on the wafer W.

The temperature of the lower electrode 406 is maintained at a predetermined level via a temperature adjustment mechanism (not shown) and a heat transfer gas at a predetermined pressure is supplied from a heat transfer gas supply source (not shown) to the space between the wafer W and the lower electrode 406. An upper electrode 408 is formed at a position facing opposite the wafer supporting surface of the lower electrode 406.

At the top of the processing container 402, a gas delivery port 420 is formed and a specific type of processing gas originating from a gas supply source (not shown) is delivered into the internal space 404 via the gas delivery port 420. The processing gas delivered into the internal space 404 is supplied toward the wafer W placed on the wafer supporting surface of the lower electrode 406 through a plurality of gas outlet holes 410 formed at the upper electrode 408. The processing gas delivered into the internal space 404 as described above may be CF₄ gas, CHF₃ gas, C₄F₈ gas, O₂ gas, He gas, Ar gas or N₂ gas, or a mixed gas constituted with a combination of these gases.

An exhaust pipe 422 is connected at the bottom of the processing container 402, and an exhaust device (not shown) is connected to the processing container 402 via the exhaust pipe 422. The pressure inside the processing container 402 is sustained at a predetermined degree of low pressure, e.g., 100 mTorr, as it is evacuated by the exhaust device. In addition, a magnet 430 is disposed at the side of the processing container 402 and a magnetic field (multipolar magnetic field) for trapping plasma near an inner wall of the processing container 402, is formed via the magnet 430. The intensity of this magnetic field is adjustable.

A power supply device 440, which supplies double frequency superimposed power is connected to the lower electrode 406. The power supply device 440 is constituted with a first power supply source 442A from which first high-frequency power (plasma generation high-frequency power) with a first frequency is supplied and a second power supply source 442B from which second high-frequency power (bias voltage generation high-frequency power) with a second frequency lower than the first frequency is supplied.

The first power supply source 442A includes a first filter 444A, a first matcher 446A and a first power source 448A connected in this order starting from the side closer to the lower electrode 406. The first filter 444A prevents entry of the power component with the second frequency toward the first matcher 446A. The first matcher 446A matches the impedance on the lower electrode side and the impedance on the first power source side with regard to the first high-frequency power component. The first frequency may be set to, for instance, 100 MHz.

The second power supply source 442B includes a second filter 444B, a second matcher 446B and a second power source 448B connected in this order starting from the side closer to the lower electrode 406. The second filter 444B prevents entry of the power component with the first frequency toward the second matcher 446B. The second matcher 446B matches the impedance on the lower electrode side and the impedance on the second power source side with regard to the second high-frequency power component. The second frequency may be set to, for instance, 3.2 MHz.

Via the power supply device 440 structured as described above, the first high-frequency power at, for instance, 100 MHz and the second high-frequency power at, for instance, 3.2 MHz superimposed upon each other, can be applied to the lower electrode 406.

In the processing chamber 220A structured as described above to function as the etching processing chamber 400, the two types of high-frequency power output from the power supply device 440 and the horizontal magnetic field formed via the magnet 430 raise the processing gas delivered into the internal space 404 to plasma and the wafer W is etched with the energy of ions and radicals accelerated by the self-bias voltage generated therein.

(Structural Example for the Hydrogen Radical Processing Chamber)

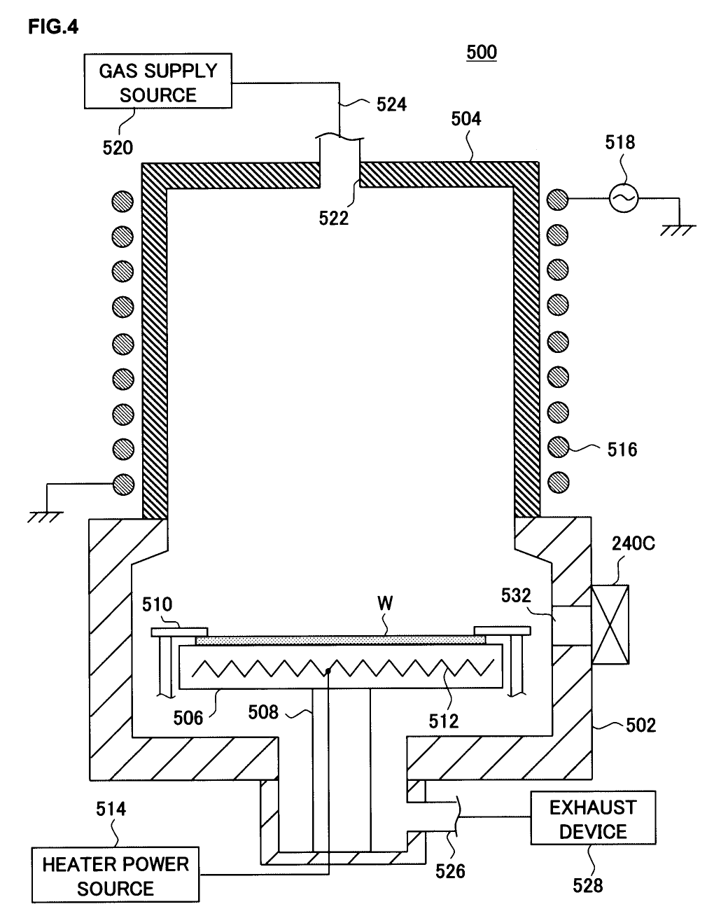

Next, a specific structural example that may be adopted in the processing chamber 220C in FIG. 1 designated as a hydrogen radical processing chamber is described in reference to a drawing. FIG. 4 is a longitudinal sectional view schematically illustrating the structure of the hydrogen radical processing chamber achieved in the embodiment. The hydrogen radical processing chamber 500 in this example is a downflow type processing chamber in which the processing is executed by using hydrogen radicals generated with plasma (hereafter may also be referred to as “hydrogen plasma”) raised through excitation of a hydrogen-containing processing gas. In the hydrogen radical processing chamber 500, hydrogen radical processing is executed to clean the film surface having become exposed through the etching process with the hydrogen radicals and also release water (dehydrate) in the low dielectric constant insulating film (e.g., a low-k film) with the hydrogen radicals.

As shown in FIG. 4, the hydrogen radical processing chamber 500 is constituted with a processing chamber body 502 where the wafer W is processed and a bell jar 504 communicating with the processing chamber body 502, where the processing gas and is excited to plasma. The bell jar 504 is disposed atop the processing chamber body 502, generates plasma with the delivered processing gas through an inductively coupled plasma (ICP) method.

More specifically, the bell jar 504 is formed in a substantially cylindrical shape by using an insulating material such as quartz or ceramic. A gas delivery port 522 is formed at the top of the bell jar 504 and a specific type of processing gas originating from a gas supply source 520 is delivered into the internal space of the bell jar 504 via the gas delivery port 522. Although not shown, a switching valve via which a gas piping 524 is opened/closed, a mass flow controller that regulates the flow rate of the processing gas and the like are disposed at the gas piping 524 connecting the gas supply source 520 to the gas delivery port 522.

The processing gas is a hydrogen-containing gas with which hydrogen radicals (H*) can be generated. Such a processing gas may be constituted with hydrogen gas alone or it may be a mixed gas containing hydrogen gas and an inert gas. The inert gas in the mixed gas may be, for instance, helium gas, argon gas or neon gas. It is to be noted that when a mixed gas containing hydrogen gas and an inert gas is used as the processing gas, the hydrogen gas should be mixed with a mixing ratio of, for instance, 4%.

A coil 516 to be used as an antenna member is wound around the outer circumference of the side wall of the cylindrical bell jar 504. The high-frequency power source 518 is connected to the coil 516. High-frequency power with its frequency set in a range of 300 kHz˜60 MHz can be output from the high-frequency power source 518. As high-frequency power with a frequency of, for instance, 450 kHz is supplied from the high-frequency power source 518 to the coil 516, an induction field is formed inside the bell jar 504. As a result, the processing gas delivered into the processing chamber body 502 becomes excited and is raised to plasma.

A disk-shaped stage 506, upon which a wafer W can be supported levelly, is disposed inside the processing chamber body 502. The stage 506 is supported by a cylindrical support number 508 disposed at the bottom of the processing chamber body 502. The stage 506 is constituted of ceramic such as aluminum nitride. A clamp ring 510, which clamps the wafer W placed on the stage 506, is disposed along the outer edge of the stage 506. In addition, a heater 512 that heats the wafer W is installed within the stage 506. As power is supplied to the heater 512 from a heater power source 514, the heater 512 heats the wafer W to a predetermined temperature (e.g., 300° C.). It is desirable that the predetermined temperature be set within a relatively high temperature range of, for instance, 250° C.˜400° C., over which water can be expelled from the low dielectric constant insulating film to a sufficient extent without significantly damaging the low dielectric constant insulating film.

An exhaust pipe 526 is connected to the bottom wall of the processing chamber body 502 and an exhaust device 528, which includes a vacuum pump, is connected to the exhaust pipe 526. As the exhaust device 528 is engaged in operation, the pressure in the processing chamber body 502 and the bell jar 504 can be lowered to achieve a predetermined degree of low pressure.

At the side wall of the processing chamber body 502, a transfer port 532 that can be opened/closed via the gate valve 240C in FIG. 1 is formed. As the gate valve 240C is opened, wafer transfer between the hydrogen radical processing chamber 500 and the common transfer chamber 210 is enabled.

In the hydrogen radical processing chamber 500 structured as described above, the wafer W is heated to the predetermined temperature, the hydrogen-containing gas used as the processing gas is supplied into the bell jar 504 and high-frequency power is supplied to the coil 516 from the high-frequency power source 518, thereby forming an induction field inside the bell jar 504. As a result, the hydrogen-containing gas in the bell jar 504 is raised to plasma and hydrogen radicals (H*) are generated. The hydrogen radical processing is executed on the wafer W with the hydrogen radicals supplied thereto. Through the hydrogen radical processing, the water present in the low dielectric constant insulating film can be released to a sufficient extent and also, any exposed surface of the metal layer such as Cu can be cleaned as well. The hydrogen radical processing is to be described in detail later.

It is to be noted that while the hydrogen radical processing chamber 500 in this example is a system in which hydrogen plasma is generated through the inductively coupled plasma method, the present invention is not limited to this example. For instance, hydrogen plasma may be generated through a microwave excitation method. Alternatively, hydrogen radicals may be generated by placing a hydrogen-containing gas in contact with a high-temperature catalyst (e.g., a high temperature catalytic wire). In addition, instead of the downflow structure explained earlier, the hydrogen radical processing chamber 500 may adopt a remote plasma structure in which plasma is generated in a space set apart from the wafer W.

(Structural Example for the Hydrophobicity Processing Chamber)

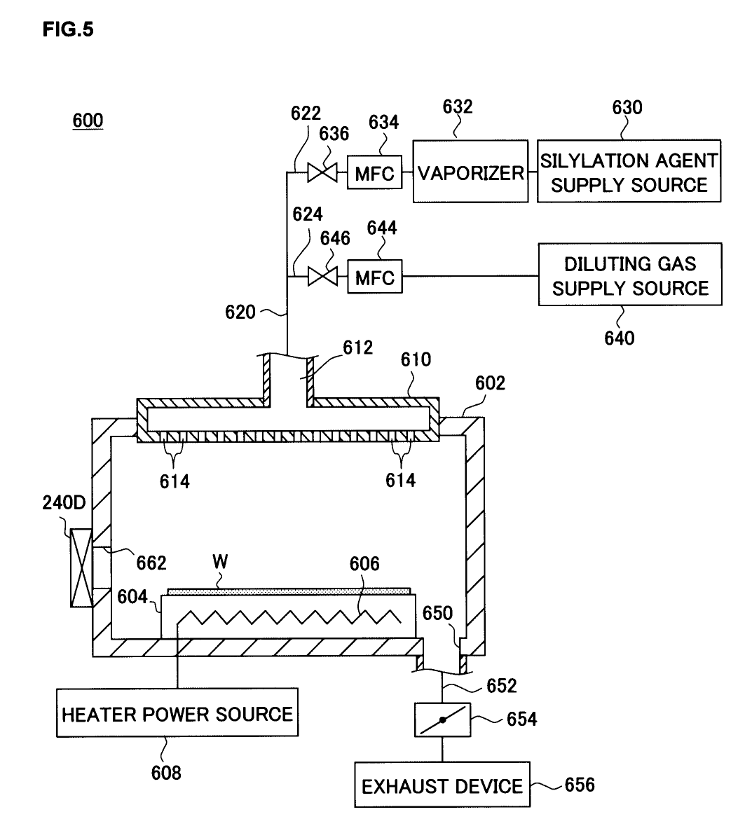

Next, a specific structural example that may be adopted in the processing chamber 220D in FIG. 1 designated as a hydrophobicity processing chamber is described in reference to a drawing. FIG. 5 is a longitudinal sectional view schematically illustrating the structure of the hydrophobicity processing chamber achieved in the embodiment. In the hydrophobicity processing chamber 600, the low dielectric constant insulating film (e.g., a low-k film) undergoes hydrophobicity processing. In the hydrophobicity processing chamber in this example, the low dielectric constant insulating film is rendered hydrophobic by silylating the surface of the low dielectric constant insulating film exposed at the wafer with a specific processing gas supplied to the wafer. In addition, the term “hydrophobicity processing” used in this context refers to a process through which the low dielectric constant insulating film such as a low-k film is treated so that further absorption of water is inhibited.

As shown in FIG. 5, the hydrophobicity processing chamber 600 includes a substantially cylindrical processing container 602 in which a wafer W is placed. The internal space of the processing container can be held in a low pressure state. A susceptor 604, upon which the wafer W to undergo the hydrophobicity processing is placed, is disposed at the bottom of the processing container 602. A built-in heater 606 used to heat the wafer W is installed within the susceptor 604. As the power is supplied to the heater 606 from a heater power source 608, the wafer W is heated to a predetermined temperature (e.g., 180° C.). It is desirable that the predetermined temperature be set within a lower temperature range of, for instance, 100° C.˜200° relative to the temperature range for the hydrogen radical processing described earlier, so that the hydrophobicity processing can be executed in an optimal manner without degrading the low dielectric constant insulating film with excessive heat. It is to be noted that while the temperature for the hydrophobicity processing is set within a relatively low range compared to the temperature setting for the hydrogen radical processing, it should still be set to a reasonably high temperature equal to or higher than 100° C. so as to ensure that any water remaining in the low dielectric constant insulating film can be released readily.

At the top position inside the processing container 602, a showerhead 610 assuming the shape of a hollow disk, via which a processing gas containing, for instance, a silylation agent (silylation agent-containing gas) is delivered into the processing container 602, is disposed so as to face opposite the susceptor 604. The showerhead 610 includes a gas delivery port 612 located at the center of the top surface thereof and numerous gas outlet holes 614 formed at the bottom surface thereof.

A gas supply piping is connected to the gas delivery port 612 and a piping 622 extending from a silylation agent supply source 630 from which the silylation agent such as TMSDMA (trimethylsilyldimethylamine) is supplied and a piping 624 extending from a diluting gas supply source 640 from which a diluting gas used to dilute the silylation agent is supplied, are connected to the gas supply piping 620. The diluting gas may be, for instance, Ar or N₂ gas.

At the piping 622, a vaporizers 632 that vaporizers the silylation agent, a mass flow controller 634 and a switching valve 636 are disposed in this order starting from the side closer to the silylation agent supply source 630. At the piping 624, a mass flow controller 644 and a switching valve 646 are disposed in this order starting from the side closer to the diluting gas supply source 640. The silylation agent vaporized via the vaporizer 632 is diluted with the diluting gas and the silylation agent-containing gas then travels through a gas supply piping 620 and the showerhead 610 to be delivered into the processing container 602.

An exhaust port 650 is present at the bottom of the processing container 602, with an exhaust pipe 652 connected to the exhaust port 650. An exhaust device 656, which includes a pressure control valve 654 and a vacuum pump such as a turbomolecular pump, is connected to the exhaust pipe 652. As the exhaust device 656 is engaged in operation, the pressure inside the processing container 602 is lowered to achieve a predetermined degree of low pressure.

A transfer port 662 that can be opened or closed via the gate valve 240D is formed at the side wall of the processing container 602. As the gate valve 240D is opened, wafer transfer between the hydrophobicity processing chamber 600 and an adjacent chamber, i.e., the common transfer chamber 210 in this example, is enabled.

In the hydrophobicity processing chamber 600 structured as described above, a specific processing gas, e.g., the silylation agent-containing gas, is supplied to the wafer W heated to the predetermined temperature. The surface of the low dielectric constant insulating film exposed at the wafer is thus silylated and as a water-repellant layer is formed at the surface, the low dielectric constant insulating film becomes hydrophobic. It is to be noted that through the silylation of the exposed surface of the low dielectric constant insulating film, the low dielectric constant insulating film is rendered hydrophobic and is also allowed to recover from any damage it may have sustained. The hydrophobicity processing is to be described in further detail later.

(Specific Example of a Film Structure at the Processing Target Wafer)

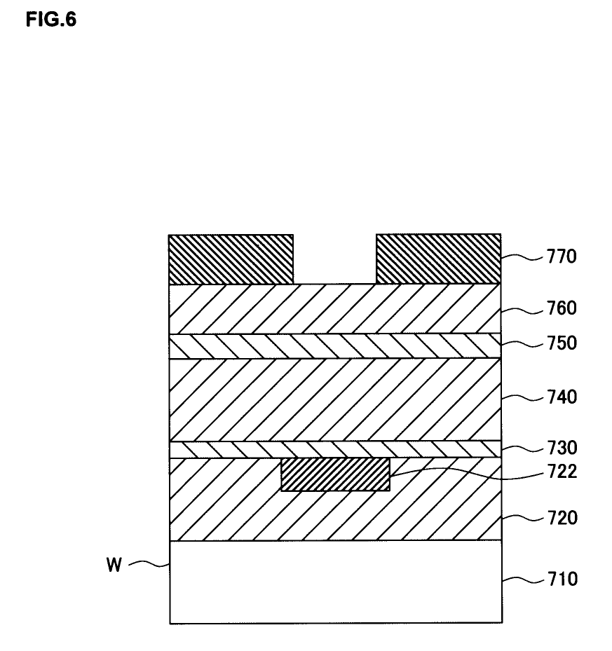

Next, a specific example of a film structure at the processing target wafer W to undergo the entire processing (etching processing, hydrogen radical processing and hydrophobicity processing) at the substrate processing apparatus 100 in the embodiment described above is explained. FIG. 6 is a sectional view of a specific example of a film structure at an unprocessed wafer W yet to undergo the processing in the substrate processing apparatus 100.

The film structure at the wafer W shown in FIG. 6 includes a plurality of films formed over a Si substrate (silicon substrate) 710. In more specific terms, it includes a base insulating film 720 constituted of SiO₂ or the like which is formed on top of the Si substrate 710, a metal layer 722 formed by burying, for instance, Cu in the base insulating film 720, an etching stopper film 730 constituted of SiC or the like, which is formed over the base insulating film 720, a low-k film (low dielectric constant insulating film) 740 formed over the etching stopper film, which is constituted of a material containing silicon and has a methyl-group skeleton, a capping film 750 formed over the low-k film and constituted of SiO₂ or the like, a bottom anti-reflection coating (BARC) 760 formed over the capping film and a photoresist film 770 formed over the antireflection coating 770.

Such a film structure can be achieved at the wafer W by executing film formation processing and the like in a specific sequence on the Si substrate 710 at a substrate processing apparatus (not shown) different from the substrate processing apparatus 100. In addition, after the photoresist film 770 is formed, the wafer W undergoes a photolithography process and thus, a specific wiring pattern is formed at the photoresist film 770.

(Specific Example of Wafer Processing)

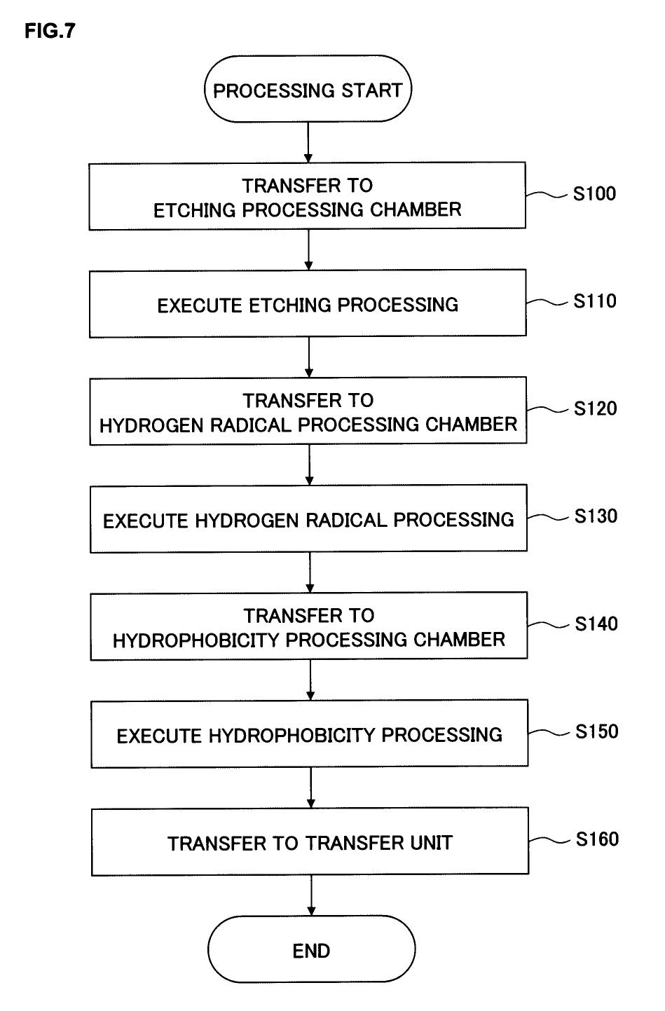

Next, in reference to a drawing, the entire sequence of processing that the wafer W undergoes at the substrate processing apparatus 100 is described. FIG. 7 presents a flowchart of the processing executed in the substrate processing apparatus 100 in the embodiment. The processing sequence is executed on the wafer W at the substrate processing apparatus 100 as the control unit 120 controls the individual units based upon a specific program. The processing the control unit to be explained in reference to the embodiment includes etching processing, hydrogen radical processing and hydrophobicity processing executed successively on a wafer W assuming a film structure such as the shown in FIG. 6, which is transferred in a low-pressure environment to various processing chambers.

In step S100, the wafer W assuming the film structure shown in FIG. 6 having been taken out of a cassette container 102, is transferred to one of the processing chambers 220A, 220B, 220E or 220F designated as etching processing chambers 400 in the substrate processing apparatus 100. More specifically, a wafer W in a cassette container 102 is transferred to the orienter 304 via the transfer unit-side transfer mechanism 320 and the wafer W is then positioned at the orienter. The wafer W having been positioned at the orienter 304 is taken back onto the transfer unit-side transfer mechanism 320 which then carries it into either the first load lock chamber 230M or the second load lock chamber 230N, e.g., the first load lock chamber 230M. Subsequently, the wafer W in the first load lock chamber 230M is carried on the processing unit-side transfer mechanism 250 into one of the processing chambers 220A, 220B, 220E or 220F designated as the etching processing chambers 400. Once placed in the etching processing chamber, the wafer W undergoes a specific type of etching processing as described below.

(Specific Example of the Etching Processing)

In reference to a drawing, a specific example of the etching processing executed in step S110 as part of the wafer processing at the substrate processing apparatus 100 in the embodiment is described. In the etching processing executed in any etching processing chamber 400 among the processing chambers 220A, 220B, 220E and 220F, the patterned photoresist film 770 is used as a mask to selectively etch the anti-reflection coating 760, the capping film 750, the low-k film 740 and the etching stopper film 730 in sequence.

The etching processing may be executed under processing conditions set as follows. The pressure inside the etching processing chamber 400 is adjusted to 100 mTorr, the level of the first high-frequency power (with a frequency of, for instance, 440 MHz) applied from the first power supply source 442A to the lower electrode 406 is set to 1000 W and the level of the second high-frequency power (with a frequency of, for instance, 13.56 MHz) applied from the second power supply source 442B to the lower electrode 406 is set to 0 W (i.e., no power is applied as the second high-frequency power). In addition, a processing gas constituted with CF₄ gas is used. The etching processing is executed over, for instance, a period of 23 seconds.

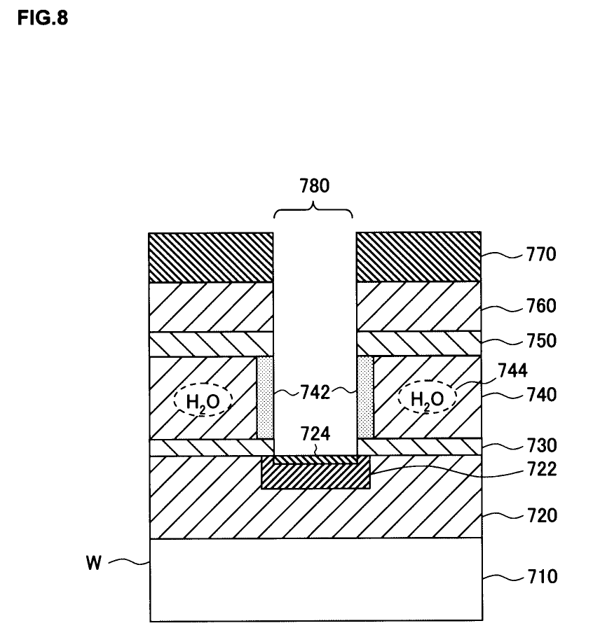

Through the etching processing executed as described above, a wiring groove (hereinafter the term “wiring groove” may also refer to a wiring hole) 780 is formed as a recessed portion in the low-k film 740 as shown in FIG. 8. As a result, the surface of the low-k film 740 becomes exposed at the side wall of the wiring groove 780 and the surface of the metal layer 722 becomes exposed at the bottom of the wiring groove 780.

(How the Etching Processing May Affect the Low-k Film and the Metal Layer)

The adverse effects of the etching processing that the low-k film and the metal layer may be subjected to are now explained. Through the etching processing, the surface of the low-k film 740 becomes exposed at the side wall of the wiring groove 780, giving rise to a concern that the exposed surface of the low-k film 740 may become damaged. There is another concern that a metal compound may settle onto the surface of the metal layer 722 exposed at the bottom of the wiring groove 780.

The adverse effects of the etching processing on the base metal layer is now described in further detail. As the low-k film 740 is etched by using the processing gas such as CF₄ gas and the metal layer 722 underneath becomes exposed at the wiring grooves 780, as shown in FIG. 8, the fluorine contained in the CF₄ gas reacts with the metal (e.g., copper) constituting the metal layer 722 and, as a result, an undesirable metal compound film (e.g., a CuF film) 724 is formed on the exposed surface. In the wiring groove 780 is formed to accommodate a wiring metal such as copper that is to be embedded in a subsequent process. The presence of the metal compound film 724 over the area where the embedded copper and the metal layer 722 are to be connected with each other is bound to increase the electrical resistance in the connection area, giving rise to a concern that desirable electrical characteristics may not be achieved in the multilayer wiring structure.

In addition, if the substrate is exposed to the air with the surface of the metal layer 722 exposed at the wiring groove 780 following the etching processing, another type of metal compound film 724 constituted with an oxide film may be formed at the exposed surface of the metal layer 722, in addition to the CuF film explained earlier. The presence of an oxide film formed at the exposed surface of the metal layer 722 is bound to further increase the electrical resistance over the connection area where the embedded wiring metal in the wiring groove 780 is to be connected with the metal layer 722. For these reasons, the metal compound films 724 such as the CuF film and the oxide film must be removed from the exposed surface of the metal layer 722 after the etching processing.

Next, the adverse effect of the etching processing on the low-k film is described in further detail. As the low-k film 740 is etched by using the processing gas such as CF₄ gas, a damaged area 742 is readily formed in the vicinity of the surface of the low-k film 740 exposed at the wiring groove 780 as shown in FIG. 8. In the damaged area 742, the methyl group (—CH₃) decreases through a reaction with the fluorine contained in the CF₄ gas and the hydroxyl group (—OH) increases through a reaction with water, resulting in an increase in the dielectric constant of the low-k film 740. If such damage is left uncorrected, the electrical characteristics of semiconductor devices produced as final products from the wafer W may be compromised. It is to be noted that while FIG. 8 schematically illustrates the damaged area 742, the boundary of the damaged area 742 and an undamaged area is not necessarily as clear as that shown in FIG. 8.

In addition, a low-k film is often constituted of a porous material which normally has a high level of water absorption capacity. In other words, the low-k film tends to readily absorb water (H₂O). For this reason, if the processing target substrate with the low-k film formed thereupon is taken out into the air, the water in the air will be readily absorbed into the low-k film. Thus, the low-k film is likely to contain water even before the etching processing takes place, and it is also highly likely that additional water present in the atmosphere will be absorbed. Furthermore, more and more water will be absorbed as time passes.

The low-k film 740 with the characteristics described above will absorb water even more readily over the damaged area 742 formed during the etching processing, as shown in FIG. 8. This means that if the wafer W is taken out of the substrate processing apparatus 100 into the air immediately after the etching processing without first executing the hydrogen radical processing and the hydrophobicity processing to be detailed later, the surface of the low-k film 740, which not yet hydrophobic will be exposed at the wiring groove 780. Under such circumstances, water (H₂O) in the air will be absorbed readily into the damaged area 742 of the low-k film 740. Moreover, the water present in the air will also be absorbed readily into the low-k film.

The presence of water 744 in the low-k film 740 degrades the quality of the low-k film 740 both with regard to its electrical characteristics and with regard to its mechanical characteristics. For instance, the dielectric constant of water is higher than that of air and thus, as the quantity of water 744 contained in the low-k film 740 increases, the overall dielectric constant of the low-k film 740 increases, resulting in poorer electrical characteristics.

In addition, the presence of water 744 in the low-k film 740 compromises the mechanical strength of the low-k film and in such a case, the shape of the wiring groove 780 with an extremely small width having been formed through etching may not be sustained until the wiring metal is embedded therein. Furthermore, various types of films including another low-k film cannot be layered upon the low-k film 740 with lowered mechanical strength in a stable manner. In other words, the low-k film 740 may not have the mechanical strength required in a multilayer wiring structure. Moreover, if the low-k film 740 does not assure a sufficient level of strength, the low-k film 740 and the film (e.g., the etching stopper film 730 or the capping film 750) in contact with the surface of the low-k film may become separated from each other.

As semiconductor circuits assume increasingly fine circuit structures with a greater number of films layered therein, it has become a crucial requirement in recent years that the low-k film 740 maintain its mechanical strength as well as its electrical characteristics. For this reason, it is essential that following the etching processing, as much water as possible should be released from the low-k film 740 and that any further absorption of water into the low-k film 740 be minimized.

Accordingly, the hydrogen radical processing is executed on the wafer W having undergone the etching processing and an the wafer W further undergoes the hydrophobicity processing in the embodiment. More specifically, upon completing the etching processing (step S110), the wafer W having been etched is transferred into the processing chamber 220C designated as the hydrogen radical processing chamber 500 in step S120 and the hydrogen radical processing is executed in step S130 as shown in FIG. 7. Next, the wafer W having undergone the hydrogen radical processing is transferred into the processing chamber 220D designated as the hydrophobicity processing chamber 600 in step S140 and the hydrophobicity processing is executed in step S150. The wafer is transferred in a low pressure environment from one processing chamber 220 to another processing chamber 220.

Through these measures, the water present in the low-k film is fully released (dehydration), further absorption of water is inhibited and the metal compound 724 present at the exposed surface of the metal layer 722 is removed. In other words, since the quality of the low-k film 740 and the metal layer 722 having become degraded can be restored and then the restored films maintain the required level of film quality, semiconductor devices assuring desirable characteristics can be formed from the wafer W. The following is a detailed explanation of the hydrogen radical processing and the hydrophobicity processing executed after the etching processing in the embodiment.

(Specific Example of the Hydrogen Radical Processing)

First, a specific example of the hydrogen radical processing (step S130) is explained in reference to a drawing. At the start of the hydrogen radical processing executed in the processing chamber 220C designated as the hydrogen radical processing chamber 500, the gate valve 240C is opened so as to allow a wafer W such as that shown in FIG. 8, having undergone the etching processing to access the processing chamber body 502. Once the wafer W is placed in the processing chamber body 502, it is transferred onto the stage 506 where it is held fast by the clamp ring 510.

Subsequently, the gate valve 240C is closed and the processing chamber body 502 and the bell jar 504 are evacuated by the exhaust device 528 until the pressure inside is reduced to a predetermined degree of low pressure (e.g., 1.5 Torr). Next, high-frequency power (e.g., 4000 W) is supplied to the coil 516 from the high-frequency power source 518 while delivering a specific gas, e.g., a mixed gas containing hydrogen gas and helium gas (with the hydrogen gas mixed with a mixing ratio of, for instance, 4%) into the bell jar 504 from the gas supply source 520 via the gas piping 524, thereby forming an induction field inside the bell jar 504. As a result, plasma and hydrogen radicals are generated inside the bell jar 504. The hydrogen radicals are then supplied to the wafer W placed further downward.

Power is supplied from the heater power source 514 to the heater 512 installed inside the stage 506. With the heat generated from the heater 512, the wafer W is heated to a predetermined temperature, e.g., 300° C.

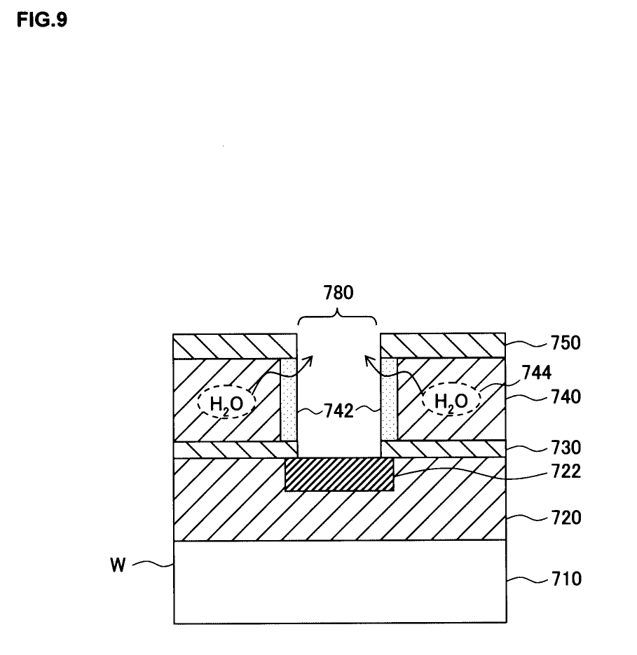

As hydrogen radicals are supplied to the wafer W and the wafer W is heated to 300° C. inside the hydrogen radical processing chamber 500, as described above, the wafer W undergoes the hydrogen radical processing. The wafer W having undergone the hydrogen radical processing may assume a film structure such as that shown in FIG. 9.

Through the hydrogen radical processing executed as described above, the film constituted of metal compounds (e.g., CuF) present at the exposed surface of the metal layer 722 becomes reduced by the hydrogen radicals and thus, the film constituted with the metal compounds can be removed, as shown in FIG. 9. Since the exposed surface of the metal layer 722 is cleaned and restored to the state of pure metal through the hydrogen radical processing, the surface resistance is greatly lowered.

In addition, since the wafer W is heated to a relatively high temperature of, for instance, 300° C. during the hydrogen radical processing, water 744 present in the low-k film can be released as well as water present at the surface of the low-k film 740. It is to be noted that water 744 present in the low-k film 740 can be released efficiently by heating the wafer W to a relatively high temperature of, for instance, 250° C. or higher during the hydrogen radical processing. However, once the temperature of the wafer W exceeds, for instance, 400° C., the low-k film 740 may become thermally degraded. Accordingly, it is desirable to set the predetermined temperature to be achieved at the wafer W during the hydrogen radical processing within a range of 250° C.˜400° C., over which water can be efficiently released from the low-k film 740 without degrading the low-k film 740.

In addition, through the action of the hydrogen radicals, the photoresist film 770 and the anti-reflection coating 760 can be removed as well. This means that as long as the hydrogen radical processing in the embodiment is executed, special ashing processing does not need to be executed in order to remove the photoresist film 770 and the antireflection coating 760, allowing an improvement in the throughput. The substrate processing apparatus 100 does not need to include a special ashing processing chamber either.

In ashing processing executed to remove the photoresist film and the like, plasma raised from an oxygen-containing gas (hereinafter may also be referred to as “oxygen-containing plasma”) is often used in the related art. However, during the ashing processing executed by using such oxygen plasma, the low-k film 740 tends to be damaged by oxygen radicals and it is extremely difficult to recover from such damage. More specifically, a chemical reaction involving oxygen radicals occurs around the damaged area 742 of the low-k film 740 having become damaged during the etching processing. The oxygen radicals penetrate the low-k film 740 through the exposed surface to form an area densely packed with Si—O (to be referred to as a “shrink layer” in the description). The shrink layer formed over the damaged area 742 makes it difficult to fully recover from the damage in the damaged area 742, since the shrink layer hinders full penetration of the silylation agent during the subsequent silylation processing.

In contrast, the hydrogen-containing gas with no oxygen atom content, is utilized in the hydrogen radical processing in the embodiment. This means that since no oxygen radicals are generated, a shrink layer densely packed with Si—O bonds is not formed over the damaged area 742 in the low-k film 740 and instead, Si—H bonds are presumably formed in the damaged area 742. Since the Si—H bonds can readily be restored to the initial state, i.e., S₁—CH₃, by using a damage restoring processing gas such as a silylation agent during the subsequent hydrophobicity processing, the damaged area 742 in the low-k film 740 can be restored to a sufficient extent. Through the hydrogen radical processing executed as described above in the embodiment, the composition at the damaged area 742 in the low-k film 740 can be modified to a composition with better restorability.

(Specific Example of the Hydrophobicity Processing)

Next, in reference to a drawing, a specific example of the hydrophobicity processing (step S150) is described. At the start of the hydrophobicity processing executed in the processing chamber 220D designated as the hydrophobicity processing chamber 600, the gate valve 240D is opened so as to allow the wafer W having undergone the hydrogen radical processing to be carried into the hydrophobicity processing chamber 600. The wafer W is then placed onto the susceptor 604.

Subsequently, the gate valve 240D is closed and the hydrophobicity processing chamber 600 is evacuated via the exhaust device 656 until a specific low-pressure state (e.g., 50 Torr) is achieved. In addition, the silylation agent such as TMSDMA originating from the silylation agent supply source 630 is supplied to the vaporizer 632 where the silylation agent is vaporized. The vaporized silylation agent is then diluted with the diluting gas supplied from the diluting gas supply source 640. The processing gas constituted with the vaporized silylation agent and the diluting gas is then delivered into the hydrophobicity processing chamber 600 via the gas supply piping 620 and the showerhead 610. As a result, the gasified silylation agent is supplied to the wafer W. The temperature at the vaporizer 632 is adjusted within a range of, for instance, room temperature ˜200° C. and the flow rate of the silylation agent is adjusted equal to or lower than 700 sccm (mL/min).

Power is supplied from the heater power source 608 to the heater 606 installed inside the susceptor 604. With the heat generated from the heater 606, the wafer W is heated to a predetermined temperature, e.g., 180° C.

The silylation agent does not need to be TMSDMA denoted by chemical formula (1) and any substance capable of inducing a silylation reaction may be used as the silylation agent. It is desirable to select a substance assuming a relatively small molecular structure among a group of compounds having a silazane (Si—N) bond within the molecules, e.g., a substance with a molecular weight of 260 or less. It is even more desirable to select a substance with a molecular weight of 170 or less. Specific examples of such substances include DMSDMA (dimethylsilyldimethylamine) denoted by chemical formula (2), HMDS (hexamethyldisilazane) denoted by chemical formula (3), TMDS (1, 1, 3, 3-tetramethyldisilazane) denoted by chemical formula (4), TMSpyrole (1-trimethylsilylpyrole) denoted by chemical formula (5), BSTFA (N, O-Bis(trimethylsilyl)trifluoroacetamide) denoted by chemical formula (6), BDMADMS (bis(dimethylamino) dimethylsilane) denoted by chemical formula (7), as well as the TMSDMA initially mentioned.

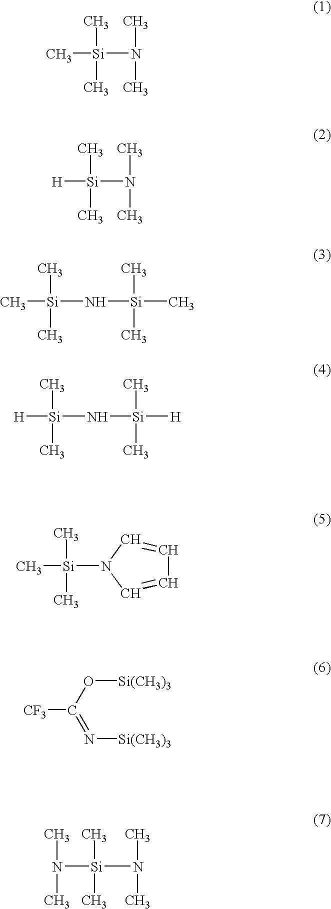

Among the compounds listed above, TMSDMA and TMDS are particularly desirable since they provide a superior dielectric constant restorative property and a superior leak current-reducing effect. A substance with a structure that includes Si constituting a silazane bond with 3 alkyl groups (e.g., methyl groups), such as TMSDMA or HMDS, is particularly desirable from the viewpoint of assuring good post-silylation stability.

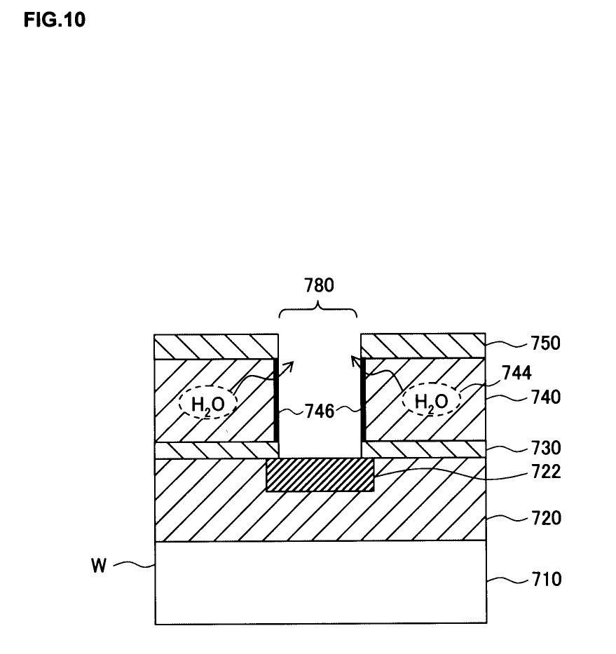

As the silylation agent is supplied to the wafer W placed inside the hydrophobicity processing chamber 600 while sustaining the temperature of the wafer W at, for instance, 180° C. as described above, the wafer W undergoes the hydrophobicity processing. FIG. 10 shows a film structure that the wafer W having undergone the hydrophobicity processing may assume.

Through the hydrophobicity processing executed by using the processing gas containing a silylation agent, as described above, a silylation reaction is induced at the damaged area 742 in the low-k film 740, as shown in FIG. 40, restoring the methyl group (—CH₃) having been reduced. Since the damaged area 742 in the low-k film 740 has been primed into a state in which it will assume a methyl group (—CH₃) composition readily through the hydrogen radical processing having been executed in the immediately preceding step, the damaged area 742 can be restored even more effectively through the hydrophobicity processing in the embodiment.

As a result, the damaged area 742 is restored so as to assume the initial composition and the damaged area 742 is thus eliminated. At the same time, since the composition at the surface of the low-k film 740 exposed at the wiring groove 780 is replaced with a methyl group (—CH₃) composition at the terminating end thereof, a water-repellent layer 764 is formed over the surface of the low-k film 740. The presence of the water-repellent layer prevents further absorption of water at the exposed surface of the low-k film 740 and also inhibits further absorption of water into the low-k film 740.

It is to be noted that the water already present in the low-k film 740 can be further reduced as the silylation reaction progresses. Since the temperature of the wafer W is sustained at a relatively high level (e.g., 180° C.) at which the quality of the low-k film 740 still remains unaffected by the heat, the water 744 remaining in the low-k film 740 can be released readily. Moreover, since the hydrophobicity processing is executed over a length of time (e.g., 150 sec) more than double the length of time (e.g., 69 sec) over which the hydrogen radical processing is executed, the wafer W is held at the high temperature over a longer period of time through the hydrophobicity processing, which allows a greater quantity of water 744 to be released.

Once the hydrophobicity processing executed on the low-k film 740 in step S150 ends, the wafer W is carried out of the processing chamber 220D used as the hydrophobicity processing chamber 600 via the processing unit-side transfer mechanism 250 installed in the common transfer chamber 210, and is transferred into either the first load lock chamber 230M or the second load lock chamber 230N, e.g. the second load lock chamber 230N. The wafer W, having been carried into the second load lock chamber 230N, is subsequently carried back into the initial cassette container 102 via the transfer unit-side transfer mechanism 320. The wafer processing in the embodiment is thus completed. The wafer W returned to the cassette container 102 is then transferred to another substrate processing apparatus (not shown) to undergo a specific type of wafer processing, e.g., copper embedding processing executed to embed copper, i.e., the wiring metal, into the wiring groove 780 formed at the low-k film 740.

Through the wafer processing executed as described above in the embodiment, water 744 can be removed from the low-k film 740 to the full extent and the presence of the water-repellent layer 746 formed through the processing inhibits further absorption of water into the low-k film 740. The wafer processing is entirely executed without ever exposing the wafer W to the air. Thus, further absorption of water 744 into the low-k film 740 while the wafer W is being transferred does not occur. Furthermore, oxidation of the exposed surface of the metal layer 722 is prevented. Consequently, the low-k film 740 maintains its initial mechanical strength and also keeps its shape. In addition, another film in contact with the low-k film 740 is not allowed to become separated from the low-k film 740 readily. Moreover, since the dielectric constant of the low-k film 740 is maintained at a low level, desirable electrical characteristics are provided.

Even if the low-k film 740 becomes damaged during the etching processing, the damaged area is repaired so as to restore the quality of the low-k film 740. Through these measures, too, desirable electrical characteristics are assured at the low-k film 740. Furthermore, the shape of the wiring groove 780 having been formed through etching can be maintained without the wiring groove becoming deformed.

Even if a metal compound film 724 is formed at the exposed surface of the metal layer 722, the surface resistance at the exposed surface of the metal layer 722 can be lowered by cleaning the exposed surface. This, in turn, makes it possible to minimize the electrical resistance over the connection area where the embedded wiring metal in the wiring groove 780 to be connected to the metal layer 722.

It is to be noted that while it is most desirable to transfer the wafer W from the hydrogen radical processing chamber 500 to the hydrophobicity processing chamber 600 in a vacuum, the wafer W should be transferred at least within a space where the moisture content and the oxygen content are controlled at low levels, in order to inhibit water penetration at the low-k film 740 and oxidation of the exposed surface of the metal layer 722.

While water in the low-k film is released in greater quantity compared to the related art through the hydrogen radical processing as described above, the exposed surface of the low-k film, unless a water-repellent layer is formed, will be in a state in which water is readily absorbed. In other words, a low-k film having undergone the hydrogen radical processing alone is likely to absorb water again. This means that if the wafer W having undergone the hydrogen radical processing is left in the air, the wafer W will absorb more moisture as time elapses, degrading both the electrical characteristics and the mechanical strength of the low-k film over time. Such degradation in the electrical characteristics and the mechanical strength of the low-k film is bound to adversely affect the processing to be executed subsequently (e.g., wet cleaning processing or wiring metal embedding processing). Accordingly, if the wafer W having undergone the hydrogen radical processing is to be taken out into the air, the interval before the subsequent processing should be minimized.

The wafer processing in the embodiment is designed to address these issues regarding the hydrogen radical processing. Namely, hydrophobicity processing is executed immediately after the hydrogen radical processing, and the wafer is transferred from the hydrogen radical processing chamber to the hydrophobicity processing chamber in a low pressure environment. As a result, a water-repellent layer is formed at the exposed surface of the low-k film through the hydrophobicity processing without allowing further absorption of additional water through the exposed surface of the low-k film having undergone the hydrogen radical processing. Thus, once the hydrophobicity processing in the embodiment is completed, water absorption through the exposed surface of the low-k film is inhibited even if the wafer W is taken out into the air, effectively preventing degradation of the electrical characteristics and the mechanical strength of the low-k film over time. The embodiment thus eliminates the need for rigorous management with regard to the length of interval to elapse before the subsequent processing. In other words, the embodiment facilitates the management of wafers W.

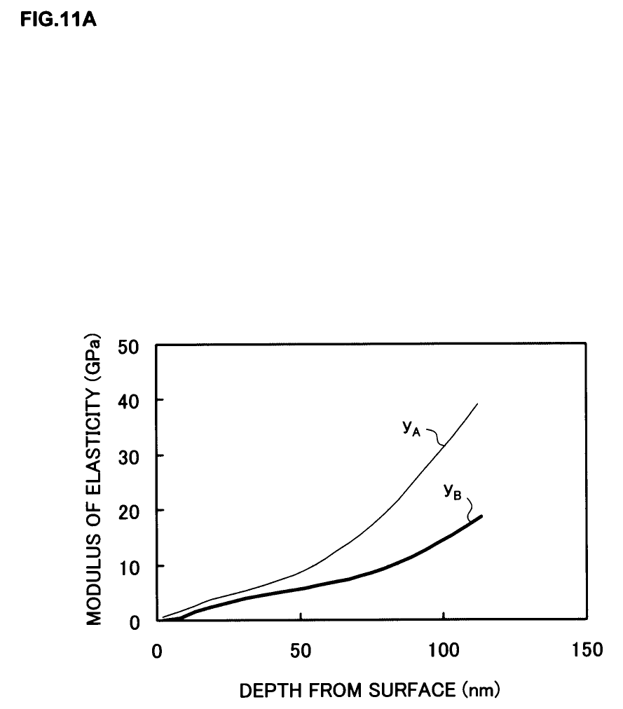

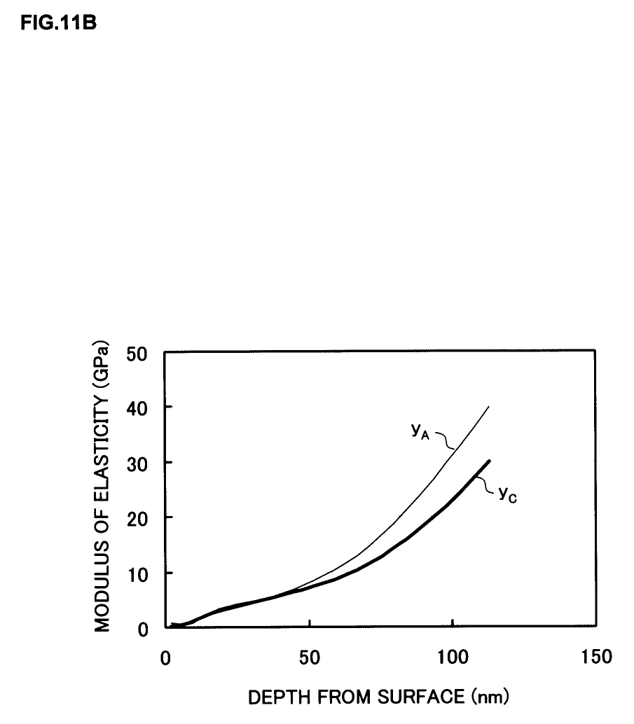

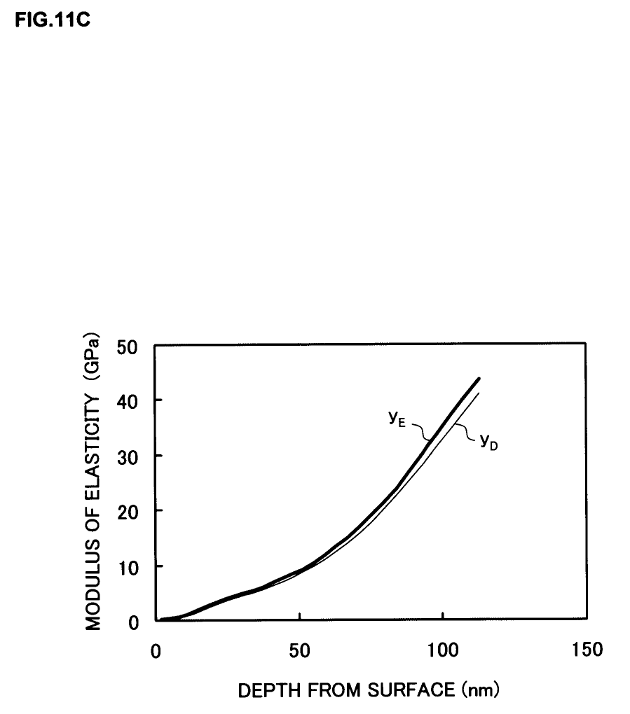

The results of tests indicating the change having occurred over time in the mechanical strength of the low-k film at a wafer having undergone the hydrogen radical processing alone and the change having occurred over time in the mechanical strength of the low-k film at a wafer having undergone the hydrogen radical processing and the hydrophobicity processing executed in succession are now described. FIG. 11A is a graph of the hardness of the low-k film (characteristics representing the modulus of elasticity) at a sample wafer having undergone the hydrogen radical processing alone, indicating the low-k film hardness detected immediately after the hydrogen radical processing (y_{A}) and the low-k film hardness detected after an interval of 48 hours during which the simple wafer was left at atmospheric pressure (y_{B}). FIG. 11B is a graph of the hardness of the low-k film (characteristics representing the modulus of elasticity) at a sample wafer having undergone the hydrogen radical processing alone, indicating the characteristics representing the modulus of elasticity detected immediately after the hydrogen radical processing (y_{A}) and the characteristics representing the modulus of elasticity detected after an interval of 48 hours during which the simple wafer was left in a low pressure environment (y_{C}). FIG. 11C is a graph of the low-k film characteristics representing the modulus of elasticity detected at the low-k film at a sample wafer having undergone the hydrogen radical processing and the hydrophobicity processing executed successively, indicating the low-k film characteristics representing the modulus of elasticity detected immediately after the execution of the hydrophobicity processing (y_{D}) and after an interval of 48 hours during which the wafer was left at atmospheric pressure (y_{E}).

The characteristics representing the modulus of elasticity of the low-k films were detected through the nano-indentation method in the tests. More specifically, an indentator (Verkovitch indentator) with its tip assuming a triangular cone shape was pressed along the depthwise direction through the surface of the subject low-k film, the extent to which the indentator penetrated the low-k film was measured with an accuracy in the nanometer order while accurately controlling the load applied to the indentator and the modulus of elasticity of the low-k film was determined by analyzing the data obtained through the measurement. In FIGS. 11A through 11C, a higher low-k film modulus of elasticity indicates better elastic characteristics achieved at the low-k film and a smaller low-k film modulus of elasticity implies deterioration in the elastic characteristics of the low-k film. In addition, the sample wafers left at atmospheric pressure were subjected to accelerated tests in which the moduli of elasticity of the low-k films were measured after they were left for an interval of 48 hours in a high humidity environment (e.g., the temperature set at 80° C. and the humidity set at 80%) at a pressure of one atmosphere.

It is to be noted that the hydrogen radical processing was executed by setting processing conditions as follows in the tests. The pressure inside the hydrogen radical processing chamber 500 was adjusted to 1.5 Torr, a mixed gas containing hydrogen gas and helium gas (with the hydrogen gas mixed with a mixing ratio of, for instance, 4%) was delivered into the hydrogen radical processing chamber 500, high-frequency power with the level thereof adjusted to 4000 W was supplied from the high-frequency power source 518 to the coil 516 and an induction field was formed inside the bell jar 504. Power was supplied from the heater power source 514 to the heater 512 installed in the stage 506 and the heater 512 thus generated heat used to sustain the temperature of the wafer W at 300° C. The hydrogen radical processing was executed over a period of 69 seconds under these conditions.

In addition, the hydrophobicity processing was executed in the tests under the processing conditions set as follows. The pressure inside the hydrophobicity processing chamber 600 was adjusted to 50 Torr and TMSDMA gas was delivered into the hydrophobicity processing chamber 600. The wafer W was heated to a predetermined temperature of, for instance, 180° C. The hydrophobicity processing was executed over a period of 150 seconds under these conditions.

The test results indicating an overall reduction in the modulus of elasticity of the low-k film after the 48-hour interval (y_{B}, y_{C}) relative to the modulus of elasticity measured immediately after the processing (y_{A}) in either wafer having undergone the hydrogen radical processing alone (see FIGS. 11A and 11B) lead us to conclude that the mechanical strength of the low-k film becomes lower over time. In addition, they indicate that the mechanical strength of the low-k film left in the high humidity environment at atmospheric pressure over a period of 48 hours (see y_{B} in FIG. 11A) was lowered to a greater extent than the mechanical strength of the low-k film left in a low humidity, low pressure environment over the 48-hour period (see y_{C} in FIG. 11B). These findings lead us to the conclusion that when there is more water present near the low-k film, water is absorbed into the low-k film in greater quantity to result in a marked reduction in the film strength.

In contrast, the elastic modulus of the low-k film at the wafer having undergone the hydrogen radical processing and the hydrophobicity processing in succession (see FIG. 11C) hardly changed after the 48-hour interval (y_{E}) compared to the elastic modulus measured immediately after the processing (y_{D}), which indicates that the mechanical strength of the low-k film at this wafer hardly changed over time. Moreover, although the wafer was left in a high humidity, atmospheric pressure environment instead of low pressure over the 48-hour period after undergoing the hydrogen radical processing and the hydrophobicity processing executed in succession, the mechanical strength of the low-k film did not become lowered.

By executing the hydrophobicity processing in immediate succession following the hydrogen radical processing as described above, the deterioration in the mechanical strength of the low-k film, which would otherwise occur over time, can be more effectively inhibited than at a wafer that undergoes the hydrogen radical processing alone. As a result, the mechanical strength of the low-k film 740 can be sustained by adopting the embodiment even when the wafer W placed in a cassette container has to be left in the air over an extended period of time in standby before undergoing the subsequent wafer processing, such as wet cleaning processing or copper embedding processing for embedding a wiring metal constituted of copper in the wiring groove 780 formed at the low-k film 740. Consequently, the wiring metal can be embedded in the wiring groove 780 retaining its initial shape. In addition, by adopting the embodiment, a multilayer wiring structure with a greater number of wiring layers can be formed.

It is to be noted that while an explanation is given above in reference to the embodiment on an example in which the substrate processing apparatus 100 includes the etching processing chambers 400, the hydrogen radical processing chamber 500 and the hydrophobicity processing chamber 600, the present invention is not limited to this example and it may be adopted in a substrate processing apparatus 100 equipped with a hydrogen radical processing chamber 500 and a hydrophobicity processing chamber 600 only with no etching processing chamber 400 formed therein. Under such circumstances, the etching processing may be executed in another substrate processing apparatus. After the etching processing executed in the other substrate processing apparatus is completed, the wafer W may be transferred at atmospheric pressure to the substrate processing apparatus 100.

In this case, the surfaces of the low dielectric constant insulating film and the metal layer exposed at the recessed portion will be exposed to the air following the etching processing and thus, moisture in the air is likely to be absorbed into the low dielectric constant insulating film and a metal oxide film constituted of an undesirable metal compound is likely to be formed at the exposed surface of the metal layer. Even under these circumstances, as the wafer W undergoes the processing in the hydrogen radical processing chamber 500 and the hydrophobicity processing chamber 600, as has been described in reference to the embodiment, moisture having been taken into the low dielectric constant insulating film from the air during the wafer transfer at atmospheric pressure, can be released to a sufficient extent and also, the undesirable metal oxide film having been formed at the surface of the metal layer can be effectively removed.

It is obvious that the present invention may be achieved by providing a system or an apparatus with a medium such as a storage medium having stored therein a software program for realizing the functions of the embodiment described above and enabling a computer (a CPU or an MPU) in the system or the apparatus to read out and execute the program stored in the medium such as a storage medium.

The functions of the embodiment described above are achieved in the program itself, read out from the medium such as a storage medium, whereas the present invention is embodied in the medium such as a storage medium having the program stored therein. The medium such as a storage medium in which the program is provided may be, for instance, a floppy (registered trademark) disk, a hard disk, an optical disk, a magneto-optical disk, a CD-ROM, a CD-R. a CD-RW, a DVD-ROM, a DVD-RAM, a DVD-RW, a DVD+RW, magnetic tape, a nonvolatile memory card or a ROM, or it may be achieved in the form of a download via a network.

It is to be noted that the scope of the present invention includes an application in which an OS or the like operating on a computer executes the actual processing in part or in whole in response to the instructions in the program read out by the computer and the functions of the embodiment are achieved through the processing thus executed, as well as an application in which the functions of the embodiments are achieved as the computer executes the program it has read out.

The scope of the present invention further includes an application in which the program read out from the medium such as a storage medium is first written into a memory in a function expansion board loaded in a computer or a function expansion unit connected to the computer, a CPU or the like in the function expansion board or the function expansion unit executes the actual processing in part or in whole in response to the instructions in the program and the functions of the embodiment described above are achieved through the processing.

While the invention has been particularly shown and described with respect to a preferred embodiment thereof by referring to the attached drawings, the present invention is not limited to this example and it will be understood by those skilled in the art that various changes in form and detail may be made therein without departing from the spirit, scope and teaching of the invention.

For instance, while silylation processing is executed as the hydrophobicity processing in the embodiment described above, the present invention is not limited to this example and the hydrophobicity processing may be executed by using another type of processing gas. In addition, the present invention may be adopted in conjunction with a low-k film constituted of MSQ (methyl-hydrogen-silsesquioxane) (either porous or dense) formed via an SOD device, an SiOC film (methyl group (—CH₃) introduced in the Si—O bond in an SiO₂ film in the related art so as to combine an Si—CH₃ bond, such as Black Diamond (manufactured by Applied Materials), Coral (manufactured by Novellus) or Aurora (manufactured by ASM), available in dense form or porous form) which is an inorganic insulating film formed through CVD, or the like.

In addition, while the processing target substrate undergoing the processing in the embodiment includes the antireflection coating (BARC) formed thereupon, such an antireflection coating is not an essential requirement of the present invention. In addition, while the embodiment of the present invention has been explained in reference to an example in which the processing target substrate is a semiconductor wafer, the present invention is not limited to this example and it may be adopted in conjunction with another type of substrate.

What is claimed is:

1. A substrate processing method adopted when executing a specific type of processing on a processing target substrate that includes a metal layer, a low dielectric constant insulating film with a low dielectric constant formed over said metal layer and a recessed portion formed in said low dielectric constant insulating film by etching said low dielectric constant insulating film until said metal layer becomes exposed, comprising:
a hydrogen radical processing phase in which the surface of said metal layer exposed at said recessed portion is cleaned and said low dielectric constant insulating film is dehydrated by supplying hydrogen radicals to said processing target substrate being heated to a predetermined temperature; and
a hydrophobicity processing phase in which said low dielectric constant insulating film exposed at said recessed portion is rendered hydrophobic by supplying a specific processing gas to said processing target substrate having undergone said hydrogen radical processing, wherein:
said hydrogen radical processing phase and said hydrophobicity processing phase are executed in succession without exposing said target processing substrate to air.

2. A substrate processing method according to claim 1, wherein:
said hydrogen radical processing phase and said hydrophobicity processing phase are executed in separate processing chambers, and said processing target substrate is transferred in a low pressure environment at least while said processing target substrate is carried from the processing chamber where said hydrogen radical processing phase is executed to the processing chamber where said hydrophobicity processing phase is executed.

3. A substrate processing method adopted when executing a specific type of processing on a processing target substrate that includes a metal layer and a low dielectric constant insulating film with a low dielectric constant formed over said metal layer, comprising:
an etching processing phase in which a recessed portion is formed in said low dielectric constant insulating film by etching said low dielectric constant insulating film until said metal layer becomes exposed;
a hydrogen radical processing phase in which the surface of said metal layer exposed at said recessed portion is cleaned and said low dielectric constant insulating film is dehydrated by supplying hydrogen radicals to said processing target substrate being heated to a predetermined temperature; and
a hydrophobicity processing phase in which said low dielectric constant insulating film exposed at said recessed portion is rendered hydrophobic by supplying a specific processing gas to said processing target substrate having undergone said hydrogen radical processing, wherein:
said etching processing phase, said hydrogen radical processing phase and said hydrophobicity processing phase are executed in succession without exposing said target processing substrate to air.

4. A substrate processing method according to claim 1, wherein:
said processing target substrate is heated to a predetermined temperature within a range of 250° C.˜400° C. during said hydrogen radical processing phase.

5. A substrate processing method according to claim 1, wherein:
said low dielectric constant insulating film is rendered hydrophobic by forming a water-repellent layer through a chemical reaction with said specific processing gas induced at the exposed surface of said low dielectric constant insulating film during said hydrophobicity processing phase.

6. A substrate processing method according to claim 5, wherein:
said specific processing gas used in said hydrophobicity processing phase is a silylating gas.

7. A substrate processing method according to claim 6, wherein:
said silylating gas is obtained from a compound that includes a silazane molecular bond (Si—N).

8. A substrate processing apparatus capable of executing a specific type of processing on a processing target substrate that includes a metal layer, a low dielectric constant insulating film with a low dielectric constant formed over said metal layer and a recessed portion formed in said low the electric constant insulating film by etching said low dialectic constant insulating film until said metal layer becomes exposed, comprising:
a hydrogen radical processing chamber in which the surface of said metal layer exposed at said recessed portion is cleaned and said low dielectric constant insulating film is dehydrated by supplying hydrogen radicals to said processing target substrate being heated to a predetermined temperature;
a hydrophobicity processing chamber in which said low dielectric constant insulating film exposed at said recessed portion is rendered hydrophobic by supplying a specific processing gas to said processing target substrate having undergone said hydrogen radical processing while the low dialectic constant insulating film is further dehydrated; and
a common low-pressure transfer chamber connected to both processing chambers via which said processing target substrate can be transferred in a low pressure environment between the processing chambers.

9. A substrate processing apparatus capable of executing a specific type of processing on a processing target substrate that includes a metal layer and a low dielectric constant insulating film with a low dielectric constant formed over said metal layer, comprising:
an etching processing chamber in which a recessed portion is formed in said low dielectric constant insulating film by etching said low dielectric constant insulating film until said metal layer becomes exposed;
a hydrogen radical processing chamber in which the surface of said metal layer exposed at said recessed portion is cleaned and said low dielectric constant insulating film is dehydrated by supplying hydrogen radicals to said processing target substrate having undergone said etching processing while heating said processing target substrate to a predetermined temperature;
a hydrophobicity processing chamber in which said low dielectric constant insulating film exposed at said recessed portion is rendered hydrophobic by supplying a specific processing gas to said processing target substrate having undergone said hydrogen radical processing; and
a low-pressure transfer chamber that includes a substrate transfer mechanism capable of transferring said processing target substrate in a low pressure environment among said etching processing chamber, said hydrogen radical processing chamber and said hydrophobicity processing chamber.

10. A computer-readable recording medium having recorded therein a program to be used to control a computer in execution of a substrate processing method adopted when executing a specific type of processing on a processing target substrate that includes a metal layer, a low dielectric constant insulating film with a low dielectric constant formed over said metal layer and a recessed portion formed in said low dielectric constant insulating film by etching said low dielectric constant insulating film until said metal layer becomes exposed, with said substrate processing method to be executed by the computer comprising:
a step in which said processing target substrate is transferred in a low pressure environment into said hydrogen radical processing chamber;
a hydrogen radical processing step in which the pressure inside said hydrogen radical processing chamber is lowered and the surface of said metal layer exposed at said recessed portion is cleaned and said low dielectric constant insulating film is dehydrated in a predetermined degree of low pressure by supplying hydrogen radicals to said processing target substrate being heated to a predetermined temperature;
a step in which said processing target substrate having undergone said hydrogen radical processing is transferred in a low pressure environment into a hydrophobicity processing chamber; and
a hydrophobicity processing step in which the pressure in said hydrophobicity processing chamber is lowered and said low dielectric constant insulating film exposed at said recessed portion is rendered hydrophobic in an environment with a predetermined degree of low pressure by supplying a specific processing gas to said processing target substrate.
